(19) United States
(12) Patent Application Publication
(10) Pub. No.: US 2021/0073014 A1
(43) Pub. Date: Mar. 11, 2021

(54) MENU GENERATION SYSTEM, MENU GENERATION METHOD, AND NON-TRANSITORY COMPUTER-READABLE STORAGE MEDIUM STORING MENU GENERATION PROGRAM

(71) Applicant: Gurunavi, Inc., Chiyoda-ku (JP)

(72) Inventors: Jun SOFUE, Chiyoda-ku (JP); Natsumi TAZUNOKI, Chiyoda-ku (JP); Satoshi OHISA, Chiyoda-ku (JP)

(73) Assignee: Gurunavi, Inc., Chiyoda-ku (JP)

(21) Appl. No.: 16/638,344

(22) PCT Filed: Apr. 27, 2018
(86) PCT No.: PCT/IB2018/000433

§ 371 Date: Feb. 25, 2020

(51) Int. Cl. G06F 9/451; G06F 40/263; G06F 3/0482; G06F 3/0484

(52) U.S. Cl. CPC G06F 9/454; G06F 40/263; G06F 40/58; G06F 3/0484; G06F 3/0482

(57) ABSTRACT

A menu generation system that stores a first menu item property in a first language and a plurality of first menu item properties in a second language in association with each other; receives a selected first menu item property in the first language, the first language being based on a setting of the user terminal, extracts the first menu item property, and transmits, to the user terminal, the extracted first menu item property in the second language for the predetermined dish.

### BACKGROUND OF THE INVENTION

### 1. Field

The present disclosure relates to a menu generation system, a menu generation method and a non-transitory computer-readable storage medium storing a menu generation program.

### 2. Description of Related Art

It is desired to provide a menu in multiple languages, translated from a menu in Japanese, to foreign tourists who visit Japan. In recent years, on various information sites that are managed in Japan, text information in contents is translated into text information in multiple languages, and the contents translated in each of the multiple languages are provided. Thus, foreign tourists are allowed to browse a menu translated in a language different from Japanese at each restaurant.

For example, Japanese Unexamined. Patent Application Publication No. 2015-194857 (JP 2015-194857 A) describes a system that converts an ingredient, a cooking style and a seasoning in a first language, input by a shop owner, into an ingredient, a cooking style and a seasoning in a second language, and that creates explanatory text of a dish based on the converted ingredient, cooking style and seasoning.

### SUMMARY OF THE INVENTION

For example, “ [symbol] ” in Japanese is written as “roast”, “bake”, or the like, in English. In this case, in a menu item, explanatory text, or the like, of a dish of which a meat ingredient is cooked by “ [symbol] ”, “ [symbol] ” in Japanese should be written as “roast” in English. In a menu item, explanatory text, or the like, of a dish of which a corn ingredient is cooked by “ [symbol] ”, “ [symbol] ” in Japanese should be written as “bake” in English.

In this way, when there are a plurality of terms of a cooking style, or the like, in the second language for a term of a cooking style, or the like, in the first language, the conventional system is occasionally not able to show foreign tourists an appropriately translated menu in the second language.

The present disclosure provides a menu generation system, a menu generation method and a non-transitory computer-readable storage medium storing a menu generation program, which are able to translate a term in a predetermined language into an appropriate term in another language.

A first aspect of the present disclosure provides a menu generation system that generates a menu of a restaurant in multiple languages. The menu generation system includes a memory and processing circuitry. The memory stores a first menu item property in a first language and a plurality of first menu item properties in a second language in association with each other. The storage unit stores each of the plurality of first menu item properties in the second language and a second menu item property in association with each other. The processing circuitry receives a selected and input first menu item property from a user terminal in the first language and a selected and input second menu item property for a predetermined dish from among menu item properties stored in the memory, the first language being based on a setting of the user terminal. The processing circuitry extracts the first menu item property in the second language, stored in the memory in association with the received second menu item property, from among the plurality of first menu item properties in the second language, stored in the memory in association with the received first menu item property in the first language. The processing circuitry transmits, to the user terminal, the extracted first menu item property in the second language for the predetermined dish.

In the menu generation system, the first menu item property may be a cooking style, and the second menu item property may be an ingredient.

In the menu generation system, the second menu item properties may have a tree structure with a plurality of levels including a primary level node relating to one or more second menu item properties associated with lower levels than the primary level, and the memory may store a property value of each second menu item property that belongs to any one of the plurality of levels and a property value of a corresponding one of the first menu item properties in association with each other. The processing circuitry identifies a second menu item as the primary level node, extracts the primary level node and one or more second menu item properties in the one or more lower levels, and transmits the extracted primary level node and the one or more second menu item properties to the user terminal.

In the menu generation system, the user terminal displays the extracted information in a menu setting in the second language.

In the menu generation system, the first menu item properties may have a tree structure with a plurality of levels, and the second menu item properties may have a tree structure with a plurality of levels.

In the menu generation system, the memory may store each of the plurality of first menu item properties in the first language and a second menu item property in association with each other.

In the menu generation system, the setting of the user terminal includes a location based setting based on a location of the user terminal at a particular point in time.

A second aspect of the invention provides a menu generation method that is executed by a computer. The computer includes a memory. The computer includes processing circuitry that generates a menu of a restaurant in multiple languages. The menu generation method includes: storing a first menu item property in a first language and a plurality of first menu item properties in a second language in the memory in association with each other and storing each of the first menu item properties in the second language and a second menu item property in the memory in association with each other, receiving a selected and input first menu item property from a user terminal in the first language and a selected and input second menu item property for a predetermined dish from among menu item properties stored in the memory the first language being based on a setting of the user terminal, extracting the first menu item property in the second language, stored in the memory in association with the received second menu item property, from among the plurality of first menu item properties in the second language, stored in the memory in association with the received first menu item property in the first language, and transmitting, to the user terminal, the extracted first menu item property in the second language for the predetermined dish.

A third aspect of the invention provides a non-transitory computer-readable storage medium storing a menu generation program. The menu generation program causes a computer, including a memory and which generates a menu of a restaurant in multiple languages, to perform a menu generation method. The method includes storing a first menu item property in a first language and a plurality of first menu item properties in a second language in the memory in association with each other and storing each of the first menu item properties in the second language and a second menu item property in the memory in association with each other, receiving a selected and input first menu item property from a user terminal in the first language and a selected and input second menu item property for a predetermined dish from among menu item properties stored in the memory the first language being based on a setting of the user terminal, extracting the first menu item property in the second language, stored in the memory in association with the received second menu item property, from among the plurality of first menu item properties in the second language, stored in the memory in association with the received first menu item property in the first language, and transmitting, to the user terminal, the extracted first menu item property in the second language for the predetermined dish.

With the menu generation system, the menu generation method and the non-transitory computer-readable storage medium storing the menu generation program according to the aspects of the present disclosure, it is possible to translate a term in a predetermined language into an appropriate term in another language.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a schematic view for illustrating the outline of a menu generation system;

FIG. 2 is a view that shows an example of the schematic configuration of the menu generation system;

FIG. 3 is a view that shows an example of the schematic configuration of a server;

FIG. 4A to FIG. 4D are views that show examples of the data structures of some of various tables;

FIG. 5A and FIG. 5B are views that show examples of the data structures of some of the various tables;

FIG. 6A and FIG. 6B are views that show examples of the data structures of some of the various tables;

FIG. 7 is a view that shows an example of the data structure of one of the various tables;

FIG. 8 is a view that shows an example of the schematic configuration of each shop terminal;

FIG. 9 is a view that shows an example of a registration page that is displayed on each shop terminal;

FIG. 10A to FIG. 10C are schematic views for illustrating an example of a method of operating a category selection drop-down list;

FIG. 11A is a view that shows an example of a detailed explanation edit page that is displayed on each shop terminal;

FIG. 11B is a schematic view for illustrating an example of a method of operating an ingredient selection drop-down list;

FIG. 11C is a schematic view for illustrating an example of a method of operating a seasoning selection drop-down list;

FIG. 11D is a schematic view for illustrating an example of a method of operating a cooking style selection drop-down list;

FIG. 12 is a view that shows an example of the schematic configuration of each mobile terminal;

FIG. 13 is a view that shows an example of a menu item information display page that is displayed on each mobile terminal;

FIG. 14 is a view that shows an example of the operation sequence of the menu generation system;

FIG. 15 is a view that shows an example of the operation flowchart of a menu item information registration process;

FIG. 16 is a view that shows an example of the operation sequence of the menu generation system;

FIG. 17A is a schematic view for illustrating an example of the tree structure of ingredients;

FIG. 17B is a view that shows another example of the data structure of an ingredient table;

FIG. 18A is a schematic view for illustrating an example of the tree structure of seasonings;

FIG. 18B is a view that shows another example of the data structure of a seasoning table;

FIG. 19A is a schematic view for illustrating an example of the tree structure of cooking styles; and

FIG. 19B is a view that shows another example of the data structure of a cooking style table.

### DETAILED DESCRIPTION OF EMBODIMENTS

Hereinafter, various embodiments of the present disclosure will be described with reference to the accompanying drawings. However, the technical scope of the present disclosure is not limited to those embodiments, and the technical scope encompasses the inventions recited in the appended claims and equivalents thereof.

### Outline of Menu Generation System 1

A menu generation system 1 has the function of generating a menu of a restaurant in multiple languages. A menu of a restaurant includes the names, categories, prices, photo images, menu item properties, and the like, of dishes that are provided by the restaurant. Each menu item property is the ingredient, seasoning, cooking style, or the like, of a dish. Hereinafter, information about a menu item of a restaurant may be referred to as menu item information.

The menu generation system 1 has the function of converting a menu item property in a first language into a menu item property in a second language. The menu item property in the first language is input by a person concerned with a restaurant, such as an owner and employee of a restaurant. The first language is a language that is generally used at a restaurant. For example, in the case of a restaurant in Japan, the first language is Japanese. The second language is a language different from the first language. When the first language is Japanese, the second language is English, Chinese (Simplified), Korean, or the like.

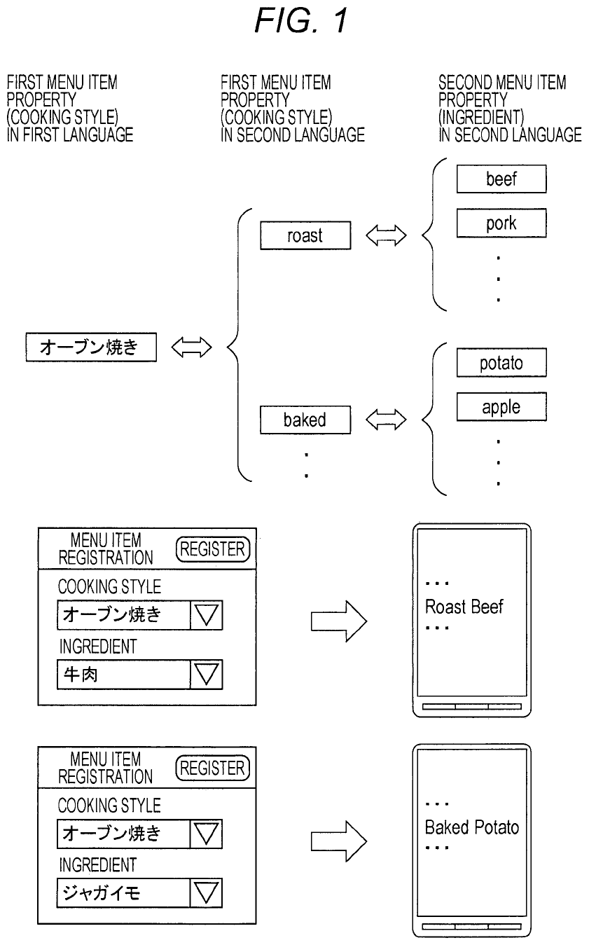

Hereinafter, the outline of the menu generation system 1 will be described with reference to the schematic view shown in FIG. 1. The case where the first language is Japanese, the second language is English, a first menu item property is a cooking style and a second menu item property is an ingredient as shown in FIG. 1 will be described as an example.

The menu generation system 1 stores text information of each menu item property in the first language and text information of the menu item property in the second language in association with each other. For example, when the first language is Japanese, the menu generation system 1 stores text information “ [symbol] ” in Japanese and text information “pork” in English in association with each other. In this way, for a term having the same meaning or similar concept, pieces of text information in two different languages are stored in association with each other; however, the number of languages in which pieces of text information are stored in association with each other is not limited to two, and may be three or more. That is, the menu generation system 1 may store pieces of text information of each menu item property in multiple languages in association with each other.

The menu generation system 1 may store a first menu item property in the first language and a plurality of first menu item properties in the second language in association with each other. For example, as shown in FIG. 1, pieces of text information of cooking styles “roast”, “baked”, and the like, in English are stored in association with text information of a cooking style “ [symbol] ” in Japanese.

The menu generation system 1 stores a first menu item property in the second language and a second menu item property in the second language in association with each other. For example, as shown in FIG. 1, both “roast” and “baked” in English have the same concept of “ [symbol] ” in Japanese; however, those pieces of text information are differently used depending on an ingredient. For this reason, the text information of the cooking style “roast” in English and pieces of text information of ingredients “beef”, “pork”, and the like, in English are stored in association with each other. Similarly, the text information of the cooking style “baked” in English and pieces of text information of ingredients “potato”, “apple”, and the like, in English are stored in association with each other.

Hereinafter, the outline of a conversion process that is executed by the menu generation system 1 will be described.

Initially, the menu generation system 1 receives a selected and input first menu item property in the first language and a selected and input second menu item property from among the stored menu item properties for a predetermined dish that is provided at each restaurant. The process of receiving a selected and input menu item property is, for example, the process of showing pieces of text information of menu item properties in the first language to a person concerned with a restaurant such that the pieces of text information of the menu item properties in the first language are selectable and then receiving the text information of the menu item property selected by the person concerned.

For example, as shown in FIG. 1, the menu generation system 1 displays a registration page on which a cooking style selection drop-down list and an ingredient selection drop-down list are provided. The cooking style selection drop-down list is used to select and input a cooking style. The ingredient selection drop-down list is used to select and input an ingredient. A person concerned with a restaurant selects a cooking style by operating the cooking style selection drop-down list on the displayed registration page. That is, one or plurality of pieces of stored text information of cooking styles are shown in a list form in the cooking style selection drop-down list, and the text information of any one of the cooking styles in the list is specified by the person concerned. Thus, the cooking style is selected. A person concerned with a restaurant selects an ingredient by operating the ingredient drop-down list on the displayed registration page, as in the case of the cooking style selection drop-down list. The menu generation system 1 receives the selected cooking style and ingredient.

Subsequently, the menu generation system 1 extracts a plurality of first menu item properties in the second language, stored in association with the received first menu item property in the first language. After that, the menu generation system 1 extracts the first menu item property in the second language, associated with the second menu item property in the second language, corresponding to the received second menu item property in the first language, from among the plurality of extracted first menu item properties.

The case where the received text information of the cooking style is “ [symbol] [symbol] ” and the received text information of the ingredient is “ [symbol] ” as shown in FIG. 1 will be described as an example. Initially, pieces of text information “roast”, “baked”, and the like, in English, stored in association with the received text information “ [symbol] [symbol] ” in Japanese are extracted. Subsequently, text information “beef” in English, corresponding to the received text information “ [symbol] ” in Japanese, is identified. The text information “roast” associated with the identified text information “beef” is extracted from among the extracted pieces of text information “roast”, “baked”, and the like, in English.

The menu generation system 1 outputs “roast” extracted in correspondence with the received “ [symbol] ” and “beef” extracted in correspondence with the received “ [symbol] ” as the converted pieces of text information of the menu item properties in the second language for a predetermined dish. The process of outputting text information includes the process of displaying text information on a display device of the menu generation system 1, the process of outputting a sound of text information to a speaker of the menu generation system 1, the process of transmitting data of text information to a terminal or another device, and the like. The terminal may be a mobile terminal that is owned by a user (customer) at each restaurant, one of a plurality of menu terminals that are installed at each restaurant and with which users at each restaurant order menu items, or the like. In the above-described embodiment, a restaurant is illustrated as a service facility. However, a service facility may not be limited to a restaurant. The present disclosure is similarly applicable to various service facilities. Examples of the various service facilities include an accommodation facility, such as a hotel and an inn, a facility for a wedding (a church, a hotel, a restaurant, a shrine, or the like), various sport facilities, such as a golf course, an entertainment facility, such as a karaoke box and a bowling alley, and the like.

When the received text information of a cooking style is “ [symbol] ” and the received text information of an ingredient is “ [symbol] ” as well, the pieces of text information of “roast”, “baked”, and the like, in English, stored in association with the received text information “ [symbol] ” in Japanese, are extracted. Subsequently, the text information “potato” in English, corresponding to the received text information “ [symbol] [symbol] ” in Japanese, is identified. The text information “baked”, associated with the identified text information “potato”, is extracted from among the extracted pieces of text information “roast”, “baked”, and the like, in English.

The menu generation system 1 outputs “baked” extracted in correspondence with the received “ [symbol] ” and “potato” extracted in correspondence with the received “ [symbol] ” as the converted pieces of text information of the menu item properties in the second language.

In this way, the menu generation system 1 is able to appropriately convert a menu item property in the first language to a menu item property in the second language, and is able to immediately provide menu item information accurately written in multiple languages.

### Configuration of Menu Generation System 1

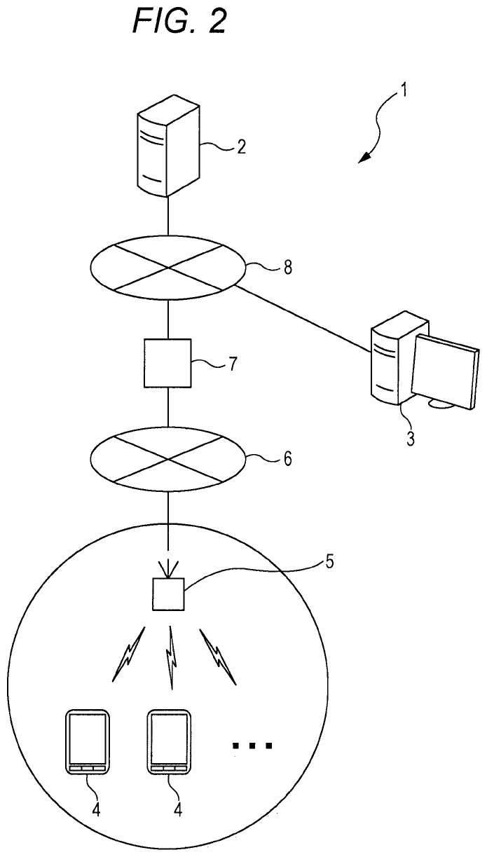

FIG. 2 is a view that shows an example of the schematic configuration of the menu generation system 1.

The menu generation system 1 includes a server 2, one or plurality of shop terminals 3, and a plurality of mobile terminals 4. The server 2 and each shop terminal 3 are connected to each other via a communication network, and are, for example, connected to each other via the Internet 8. The server 2 and each mobile terminal 4 are connected to each other via a communication network, and are, for example, connected to each other via a base station 5, a mobile communication network 6, a gateway 7 and the Internet 8. Each shop terminal 3 is a dish provider terminal that is owned by a person concerned with a restaurant, and is, for example, installed at a shop, or the like, of a restaurant that a person concerned with the restaurant manages. Each of the mobile terminals 4 is a user terminal of a customer who utilizes a restaurant, a user terminal of a person concerned with a restaurant, or the like.

A program (for example, a conversion program) that is executed by the server 2 and a program (for example, a browsing program) that is executed by each shop terminal 3 or each mobile terminal 4 carry out communication with each other by using a communication protocol, such as a hypertext transfer protocol (HTTP).

### Schematic Configuration of Server 2

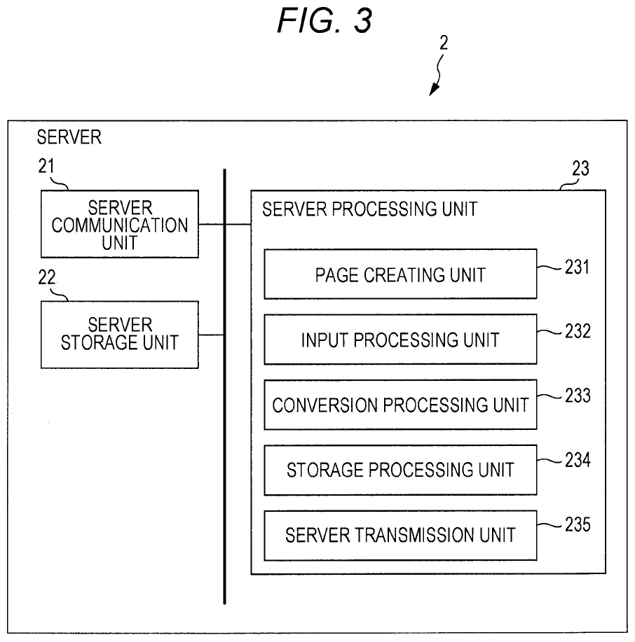

FIG. 3 is a view that shows an example of the schematic configuration of the server 2.

The server 2 stores pieces of text information of each menu item property in multiple languages in association with each other, and stores a second menu item property in association with a first menu item property. The server 2 receives a selected and input first menu item property in the first language and a selected and input second menu item property from among the stored menu item properties. The server 2 extracts a first menu item property in the second language, stored in association with the received second menu item property, from among one or plurality of first menu item properties in the second language, stored in association with the received first menu item property in the first language. Subsequently, the server 2 outputs the extracted first menu item property in the second language. In order to implement the above-described functions, the server 2 includes a server communication unit 21, a server storage unit 22, and a server processing unit 23.

The server communication unit 21 includes a communication interface circuit for connecting the server 2 to the Internet 8. The server communication unit 21 supplies data, received from each shop terminal 3, each mobile terminal 4, and the like, to the server processing unit 23. The server communication unit 21 transmits data, supplied from the server processing unit 23, to each shop terminal 3, each mobile terminal 4, and the like.

The server storage unit 22, for example, includes at least one of a semiconductor memory, a magnetic disk drive and an optical disk drive. The server storage unit 22 stores a driver program, an operating system program, an application program, data, and the like, that are used for processing in the server processing unit 23. For example, the server storage unit 22 stores a communication device driver program that controls the server communication unit 21, and the like, as the driver program. Each of the various programs may be installed from a computer-readable portable storage medium, such as a CD-ROM and a DVD-ROM, into the server storage unit 22 with the use of a known setup program, or the like. The server storage unit 22 stores a category table, an ingredient table, a seasoning table, a cooking style table, a restaurant table, a term dictionary table, a property related table, a detailed explanation dictionary table, a menu item information table, and the like (described later), as the data. Furthermore, the server storage unit 22 may temporarily store temporary data associated with predetermined processing.

Each table in the present embodiment is an example of a database format, and may be of a type in which data are pooled inside the server 2.

The server processing unit 23 includes one or plurality of processors and their peripheral circuit (processing circuitry). The server processing unit 23 is to generally control the overall operations of the server 2. The server processing unit 23 is, for example, a central processing unit (CPU). The server processing unit 23 controls the operations of the server communication unit 21, and the like, such that the server 2 executes various processing in an appropriate procedure on the basis of the programs, and the like, that are stored in the server storage unit 22. The server processing unit 23 executes processing on the basis of the programs (the operating system program, the driver program, the application program, and the like) that are stored in the server storage unit 22. The server processing unit 23 is able to execute a plurality of programs (application programs, or the like) in parallel.

The server processing unit 23 includes a page creating unit 231, an input processing unit 232, a conversion processing unit 233, a storage processing unit 234 and a server transmission unit 235. These units of the server processing unit 23 are functional modules that are implemented by programs that are executed by the processor(s) of the server processing unit 23. Alternatively, these units of the server processing unit 23 may be implemented in the server 2 as an independent integrated circuit, a microprocessor or firmware.

### Data Structures of Various Tables

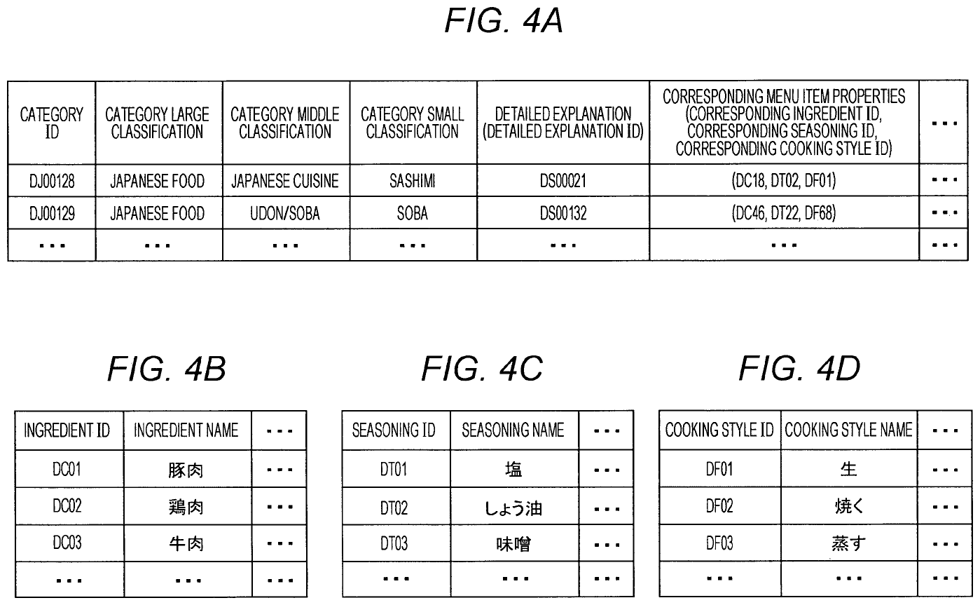

FIG. 4A to FIG. 7 are views that show examples of the data structures of some of the various tables. The server storage unit 22 may not store part or all of the various tables that will be described below. Instead, one or plurality of other devices different from the server 2 (such as a database device) may store part or all of these various tables. In this case, at the time when the server 2 uses information stored in these various tables, the server 2 accesses another device that stores the tables and acquires information stored in the tables. Pieces of information, contained in each table, may be stored in format other than table format or may be, for example, stored independently. Hereinafter, description will be made on the assumption that the first language is Japanese; however, the first language may be a language other than Japanese. Hereinafter, description will be made on the assumption that the second language is English, a third language is Chinese (Simplified) and a fourth language is Korean; however, the second language may be any language as long as the second language is a language other than the first language. Similarly, the third language may be any language as long as the third language is a language other than the first language or the second language, and the fourth language may be any language as long as the fourth language is a language other than the first language, the second language, or the third language.

FIG. 4A shows a category table. A category ID (identification), a category large classification, a category middle classification, a category small classification, a detailed explanation, corresponding menu item properties, and the like, are stored in the category table in association with one another for each category. The category ID is identification information for identifying each category.

The category large classification is text information of a classification item for classifying each dish, and includes, for example, “Japanese food”, “grilled meat”, “Italian food”, and the like. The category middle classification is text information of a classification item for further classifying each classification item contained in the category large classification. For example, the pieces of text information of classification items of the category middle classification, contained in “Japanese food”, are “Japanese cuisine”, “kappo”, “udon/soba”, and the like. The category small classification is text information of a classification item for further classifying each classification item contained in the category middle classification. For example, the pieces of text information of classification items of the category small classification, contained in “udon/soba”, are “soba”, “udon”, “Sanuki udon”, and the like. The category large classification, the category middle classification and the category small classification are examples of a category. The pieces of text information of the classification items in each of the category large classification, the category middle classification and the category small classification are examples of text information of a category. For example, when the pieces of text information of the classification items of the category large classification, category middle classification and category small classification are stored in association with one another, the pieces of text information of the classification items of the category small classification are used as categories. When the pieces of text information of the classification items of the category large classification and category middle classification are stored in association with one another (when the pieces of text information of the classification items of the category small classification are not stored), the pieces of text information of the classification items of the category middle classification are used as categories. When only the pieces of text information of the classification items of the category large classification are stored (when the pieces of text information of the classification items of the category middle classification and category small classification are not stored), the pieces of text information of the classification items of the category large classification are used as categories.

A detailed explanation ID that is stored in the detailed explanation dictionary table (described later) is stored in the column of the detailed explanation. Thus, each category is associated with text information of the detailed explanation for explaining the category. For example, when categories are the classification items of the category small classification, the detailed explanation IDs of detailed explanations that explain the classification items of the category small classification are stored in the column of the detailed explanation. When categories are the classification items of the category middle classification, the detailed explanation IDs of detailed explanations that explain the classification items of the category middle classification are stored in the column of the detailed explanation. When categories are the classification items of the category large classification, the detailed explanation IDs of detailed explanations that explain the classification items of the category large classification are stored in the column of the detailed explanation.

A corresponding ingredient ID, a corresponding seasoning ID and a corresponding cooking style ID are stored in the column of the corresponding menu item property in association with one another. The corresponding ingredient ID is the ingredient ID of an ingredient that is used for a dish corresponding to the category among the ingredient IDs stored in the ingredient table (described later). The corresponding seasoning ID is the seasoning ID of a seasoning that is used for a dish corresponding to the category among the seasoning IDs stored in the seasoning table (described later). The corresponding cooking style ID is the cooking style ID of a cooking style that is used for a dish corresponding to the category among the cooking style IDs stored in the cooking style table (described later).

FIG. 4B shows the ingredient table. An ingredient ID, an ingredient name, and the like, are stored in the ingredient table for each ingredient in association with one another. The ingredient ID is identification information for identifying each ingredient. The ingredient name is text information of the name of each ingredient in the first language (Japanese).

FIG. 4C shows the seasoning table. A seasoning ID, a seasoning name, and the like, are stored in the seasoning table in association with one another for each seasoning. The seasoning ID is identification information for identifying each seasoning. The seasoning name is text information of the name of each seasoning in the first language (Japanese).

FIG. 4D shows the cooking style table. A cooking style ID, a cooking style name, and the like, are stored in the cooking style table in association with one another for each cooking style. The cooking style ID is identification information for identifying each cooking style. The cooking style name is text information of the name of each cooking style in the first language (Japanese).

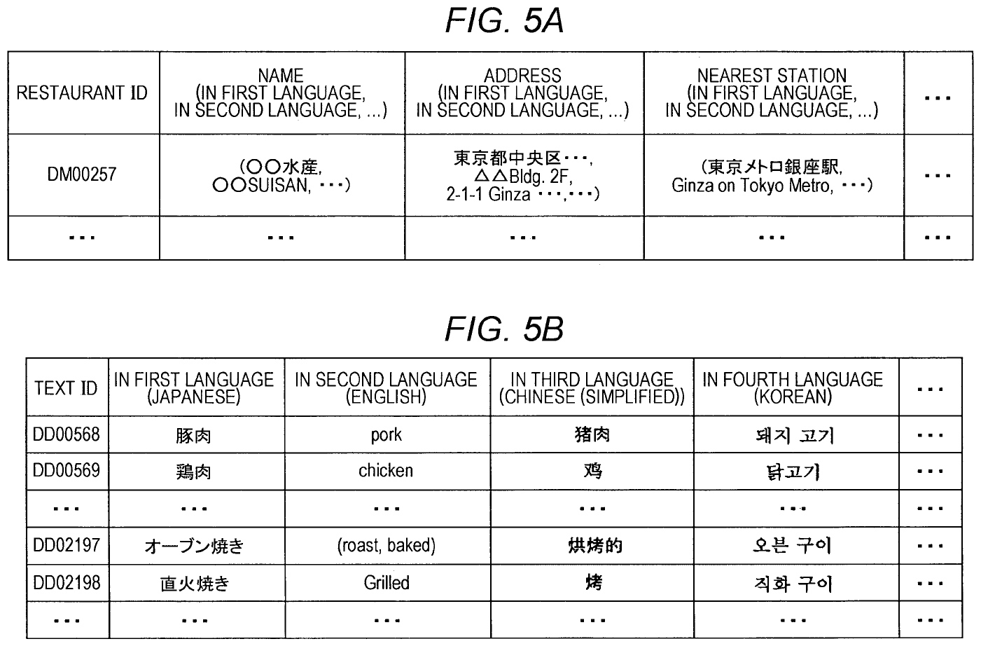

FIG. 5A shows the restaurant table. A restaurant ID, a name, an address, a nearest station, and the like, are stored in the restaurant table in association with one another for each restaurant. The restaurant ID is an example of restaurant identification information for identifying each restaurant. Text information of the name of a restaurant in the first language (Japanese), text information of the name of the restaurant in the second language (English), and the like, are stored in the column of the name in association with one another. Text information of the address of a restaurant in the first language (Japanese), text information of the address of the restaurant in the second language (English), and the like, are stored in the column of the address in association with one another. Text information of the nearest station of a restaurant in the first language (Japanese), text information of the nearest station of the restaurant in the second language (English), and the like, are stored in the column of the nearest station in association with one another.

The pieces of text information of the name, address and nearest station in three or more languages (the first language (Japanese), the second language (English), the third language (Chinese (Simplified)), the fourth language (Korean), . . . ) may be stored in the restaurant table in association with one another. The data stored in the restaurant table are registered by persons concerned with restaurants, or the like, in advance.

FIG. 5B shows the term dictionary table. A text ID, text in the first language (Japanese), text in the second language (English), text in the third language (Chinese (Simplified)), text in the fourth language (Korean), and the like, are stored in the term dictionary table in association with one another for each of pieces of text information of the category and menu item property. The text ID is identification information for identifying each piece of text information.

The pieces of text information of categories and menu item properties in the first language (Japanese) are contained in the column of the text in the first language (Japanese). The pieces of text information of categories and menu item properties in the second language (English) are contained in the column of the text in the second language (English). The pieces of text information of categories and menu item properties in the third language (Chinese (Simplified)) are contained in the column of the text in the third language (Chinese (Simplified)). The pieces of text information of categories and menu item properties in the fourth language (Korean) are contained in the column of the text in the fourth language (Korean). Text in five or more languages may be stored in the term dictionary table in association with one another for each piece of text information.

A plurality of pieces of text information of categories and menu item properties in another language may be stored in association with a piece of text information of a category and menu item property in the first language (Japanese). For example, as shown in FIG. 5B, a plurality of pieces of text information, that is, “roast” and “baked” in the second language (English), are stored in association with text information “ [symbol] [symbol] ” in the first language (Japanese).

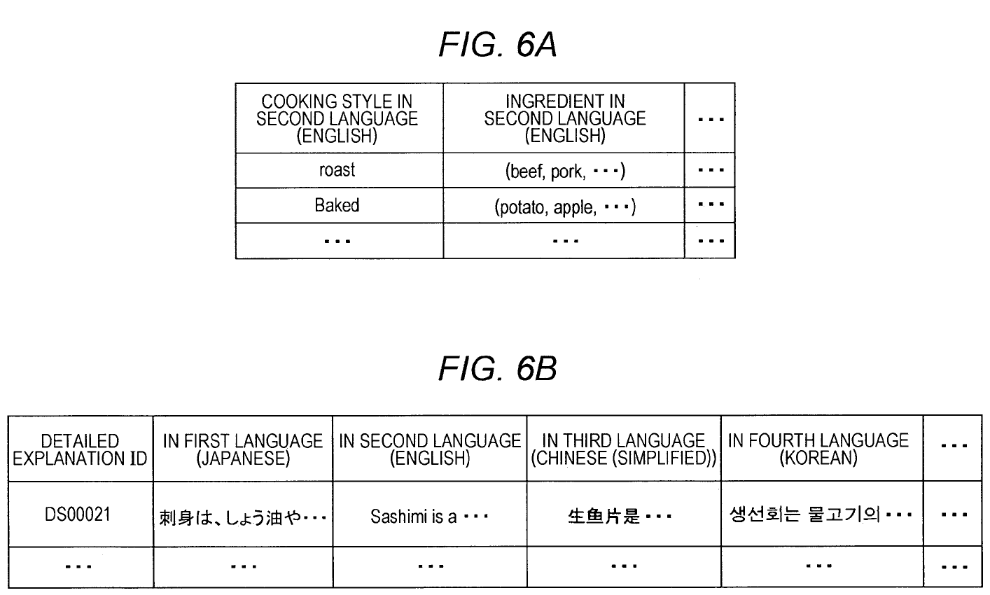

FIG. 6A shows the property related table. Pieces of text information of cooking styles in the second language (English) and pieces of text information of ingredients in the second language (English) are stored in the property related table in association with each other. Pieces of text information of cooking styles in a language different from the second language and pieces of text information of ingredients in the language different from the second language may be stored in the property related table in association with each other. Pieces of text information of ingredients in a predetermined language and pieces of text information of seasonings in the predetermined language may be stored in the property related table in association with each other. Alternatively, pieces of text information of cooking styles in a predetermined language and pieces of text information of seasonings in the predetermined language may be stored in the property related table in association with each other. As shown in FIG. 6A, a plurality of pieces of text information of cooking styles in the second language (English) and a plurality of pieces of text information of ingredients in the second language (English) are stored in the property related table in association with each other. On the other hand, each of the plurality of pieces of text information of cooking styles in the second language (English) and each of the plurality of pieces of text information of cooking styles in the first language (Japanese) are stored in the term dictionary table of FIG. 5B in association with each other, and each of the plurality of pieces of text information of ingredients in the first language (Japanese) and each of the plurality of pieces of text information of ingredients in the second language (English) are stored in the term dictionary table of FIG. 5B in association with each other.

FIG. 6B shows the detailed explanation dictionary table. A detailed explanation ID, text in the first language (Japanese), text in the second language (English), text in the third language (Chinese (Simplified)), text in the fourth language (Korean), and the like, are stored in the detailed explanation dictionary table in association with one another for each detailed explanation. The detailed explanation ID is identification information for identifying each detailed explanation.

A detailed explanation in the first language (Japanese) is contained in the column of the text in the first language (Japanese). A detailed explanation in the second language (English) is contained in the column of the text in the second language (English). A detailed explanation in the third language (Chinese (Simplified)) is contained in the column of the text in the third language (Chinese (Simplified)). A detailed explanation in the fourth language (Korean) is contained in the column of the text in the fourth language (Korean). Text in five or more languages may be stored in the detailed explanation dictionary table in association with one another for each detailed explanation.

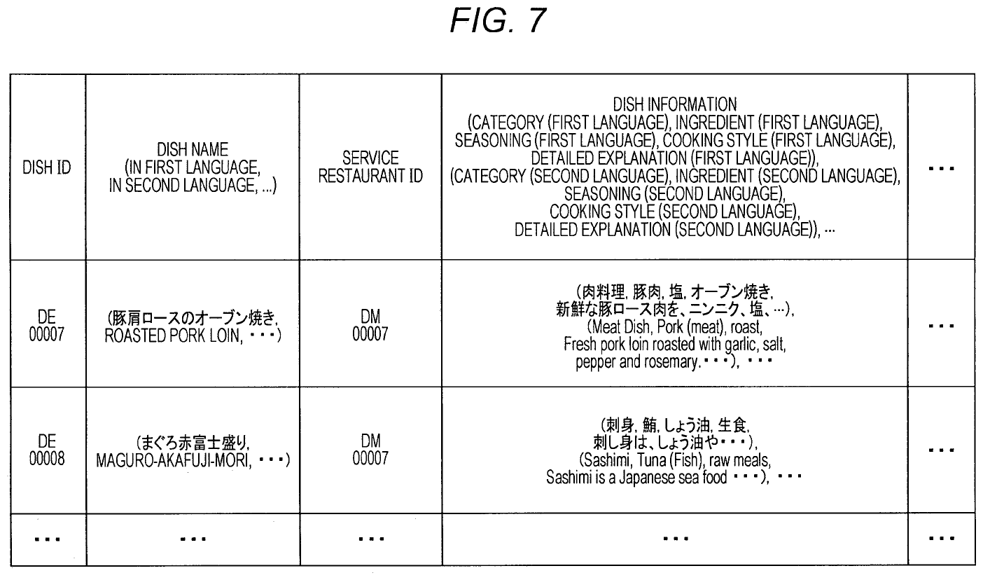

FIG. 7 shows the menu item information table. A dish ID, a dish name, a service restaurant ID, dish information, and the like, are stored in the menu item information table in association with one another for each dish. The menu item information contains the dish name of each dish, information about a restaurant that provides the dish, dish information, and the like.

The dish ID is identification information for identifying each dish. The dish name is text information of the name of each dish in multiple languages, input in text by a user, such as a person concerned with a restaurant, who operates the shop terminal 3. A dish name in the first language, a dish name in the second language, and the like, are stored in the column of the dish name. Instead, pieces of text information of dish name in three or more languages (the first language (Japanese), the second language (English), the third language (Chinese (Simplified)), the fourth language (Korean), . . . ) may be stored in the column of the dish name.

The service restaurant ID is the restaurant ID of a restaurant that provides each dish, and is the restaurant ID that is stored in the restaurant table. A service restaurant ID is associated with each dish, so each dish and information about a restaurant that provides the dish are associated with each other.

The dish information is information for introducing each dish to a user (customer), or the like, of a restaurant. A category, menu item properties (ingredient, seasoning, and cooking style) and detailed explanation in the first language (Japanese), a category, menu item properties (ingredient, seasoning, cooking style) and detailed explanation in the second language (English), and the like, are stored in the column of the dish information.

Pieces of text information of category and menu item properties selected and input by the user are stored in the column of category and menu item properties in the first language (Japanese). Pieces of text information of category and menu item properties in the second language (English), converted from the selected and input pieces of text information of category and menu item properties in the first language (Japanese) by the menu generation system 1, are stored in the column of category and menu item properties in the second language (English). The detailed explanation in the first language (Japanese) is the detailed explanation associated with the input category in the first language (Japanese) in the category table. The detailed explanation of the dish in the second language (English) is text information of the detailed explanation in the second language (English), converted by the menu generation system 1 from the text information of the detailed explanation in the first language (Japanese), in the detailed explanation dictionary table.

Dish information in three or more languages (the first language (Japanese), the second language (English), the third language (Chinese (Simplified)), the fourth language (Korean), . . . ) may be stored in the menu item information table. A registration date and time at which the dish name, dish information, and the like, of each dish have been received by the input processing unit 232 may be stored in the menu item information table in association with the dish.

### Schematic Configuration of Shop Terminal 3

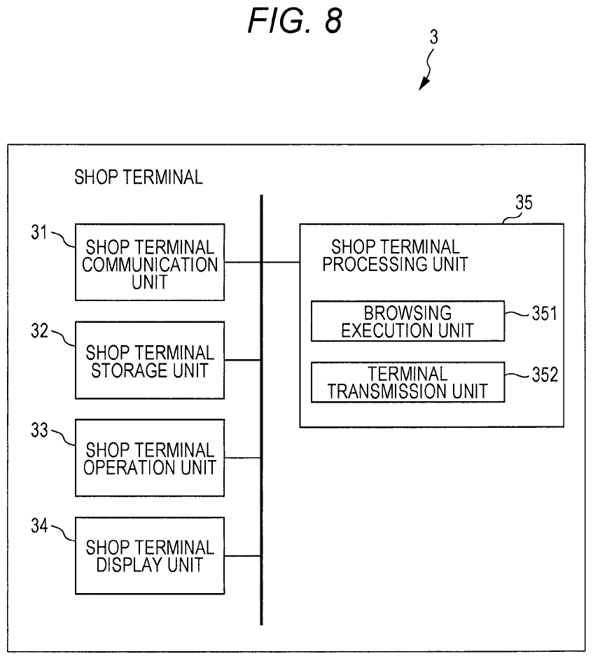

FIG. 8 is a view that shows an example of the schematic configuration of each shop terminal 3.

Each shop terminal 3 is connected to the server 2 via the Internet 8 (FIG. 1), and carries out communication with the server 2. Each shop terminal 3 receives input of a menu item property, or the like, in response to an input operation of a person concerned with a corresponding restaurant. For the purpose of this, each shop terminal 3 includes a shop terminal communication unit 31, a shop terminal storage unit 32, a shop terminal operation unit 33, a shop terminal display unit 34 and a shop terminal processing unit 35. Hereinafter, the person concerned with the restaurant, who operates the shop terminal 3, may be simply referred to as user.

In the present embodiment, a personal computer (PC) is assumed as each shop terminal 3; however, the present disclosure is not limited to employing a personal computer (PC) as each shop terminal 3. Each shop terminal 3 may be any device as long as the present disclosure is applicable. For example, each shop terminal 3 may be an information processing device, such as a multifunctional mobile phone (smartphone), a mobile phone (feature phone), a mobile information terminal (personal digital assistant (PDA)), a portable game machine, a portable audio player, a tablet terminal, a tablet PC and a notebook PC. Each shop terminal 3 may be a menu terminal, or the like, that is installed at a restaurant and that a person concerned with the restaurant, or the like, uses.

The shop terminal communication unit 31 includes a communication interface circuit. The shop terminal communication unit 31 connects the corresponding shop terminal 3 to the Internet 8 (FIG. 1). The shop terminal communication unit 31 transmits data, supplied from the shop terminal processing unit 35, to the server 2, or the like, via the network. The shop terminal communication unit 31 supplies the shop terminal processing unit 35 with data received from the server 2, or the like, via the network.

The shop terminal storage unit 32 includes, for example, a semiconductor memory device. The shop terminal storage unit 32 stores an operating system program, a driver program, an application program, data, and the like, that are used for processing in the shop terminal processing unit 35. For example, the shop terminal storage unit 32 stores an input device driver program that controls the shop terminal operation unit 33, an output device driver program that controls the shop terminal display unit 34, and the like, as the driver program. The shop terminal storage unit 32 stores a browsing program, or the like, for displaying a registration page for registering menu item properties, and the like, input through user's operation on the shop terminal operation unit 33, into the server 2 as the application program. The shop terminal storage unit 32 stores the input menu item properties, and the like. Furthermore, the shop terminal storage unit 32 may temporarily store temporary data associated with predetermined processing.

The shop terminal operation unit 33 may be any device as long as the shop terminal 3 is operable by using the shop terminal operation unit 33, and is, for example, a touch panel, a key button, or the like. The user is allowed to input characters, numerics, symbols, and the like, with the use of the shop terminal operation unit 33. As the shop terminal operation unit 33 is operated by the user, the shop terminal operation unit 33 generates a signal corresponding to the operation. The generated signal is supplied to the The shop terminal display unit 34 may also be any device as long as the shop terminal display unit 34 is able to display video, an image, and the like. The shop terminal display unit 34 may be, for example, a liquid crystal display, an organic electro-luminescence (EL) display, or the like. The shop terminal display unit 34 displays video based on video data, an image based on image data, or the like, supplied from the shop terminal processing unit 35.

The shop terminal processing unit 35 includes one or plurality of processors and their peripheral circuit. The shop terminal processing unit 35 is to generally control the overall operations of the corresponding shop terminal 3. The shop terminal processing unit 35 is, for example, a central processing unit (CPU). The shop terminal processing unit 35 controls the operations of the shop terminal communication unit 31, shop terminal display unit 34, and the like, such that the corresponding shop terminal 3 executes various processing in an appropriate procedure on the basis of the programs that are stored in the shop terminal storage unit 32, an operation on the shop terminal operation unit 33, and the like. The shop terminal processing unit 35 executes processing on the basis of the programs (the operating system program, the driver program, the application program, and the like) that are stored in the shop terminal storage unit 32. The shop terminal processing unit 35 is able to execute a plurality of programs (application programs, or the like) in parallel.

The shop terminal processing unit 35 includes at least a browsing execution unit 351, a terminal transmission unit 352, and the like. These units are functional modules that are implemented by programs that are executed by the processor(s) of the shop terminal processing unit 35. Alternatively, these units may be implemented in each shop terminal 3 as firmware.

### Functions of Shop Terminal 3

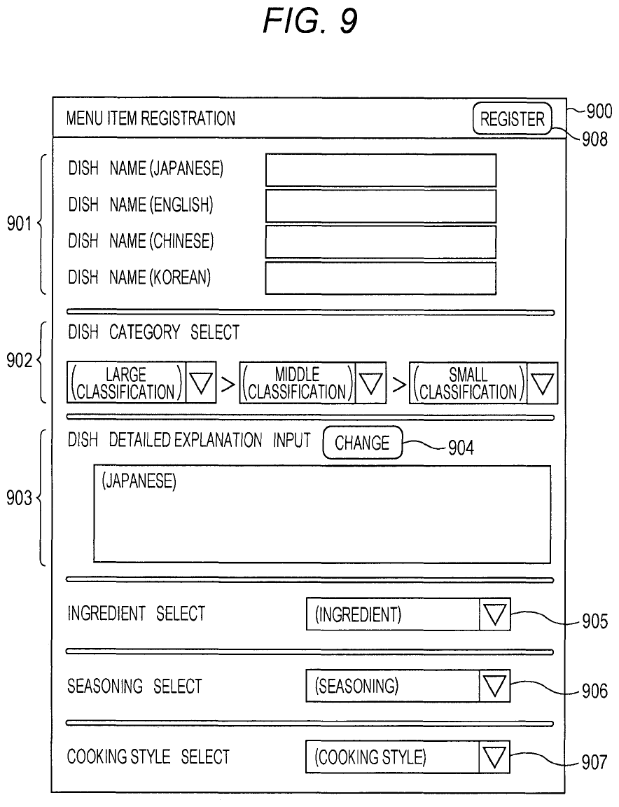

FIG. 9 to FIG. 11D are views that show examples of display pages that are displayed by the display function of each shop terminal 3. Display pages for registering menu item information are displayed by the display function of each shop terminal 3.

FIG. 9 is a view that shows an example of a registration page 900 that is displayed by the display function of each shop terminal 3.

The registration page 900 is a page that is displayed when a request to display the registration page 900 has been issued from a person concerned with a restaurant. Dish name input boxes 901, category selection drop-down lists 902, a detailed explanation display box 903, a detailed explanation change button 904, an ingredient selection drop-down list 905, a seasoning selection drop-down list 906, a cooking style selection drop-down list 907, a registration button 908, and the like, are displayed on the registration page 900.

The dish name input boxes 901 are boxes for allowing a person concerned with a restaurant that provides each dish to input information about the name of a predetermined dish in text. The plurality of dish name input boxes 901 are provided in a plurality of languages, including Japanese, English, Chinese, and, but not limited to, Korean. In one example, the person concerned with the restaurant may input the name of the dish in the language he/she knows (e.g., if person concerned with the restaurant is Japanese, or if the restaurant is located in Japan, then the person concerned with the restaurant may elect to enter the name of the dish in Japanese only. Alternatively, the person concerned with the restaurant may input the name of the dish in multiple languages).

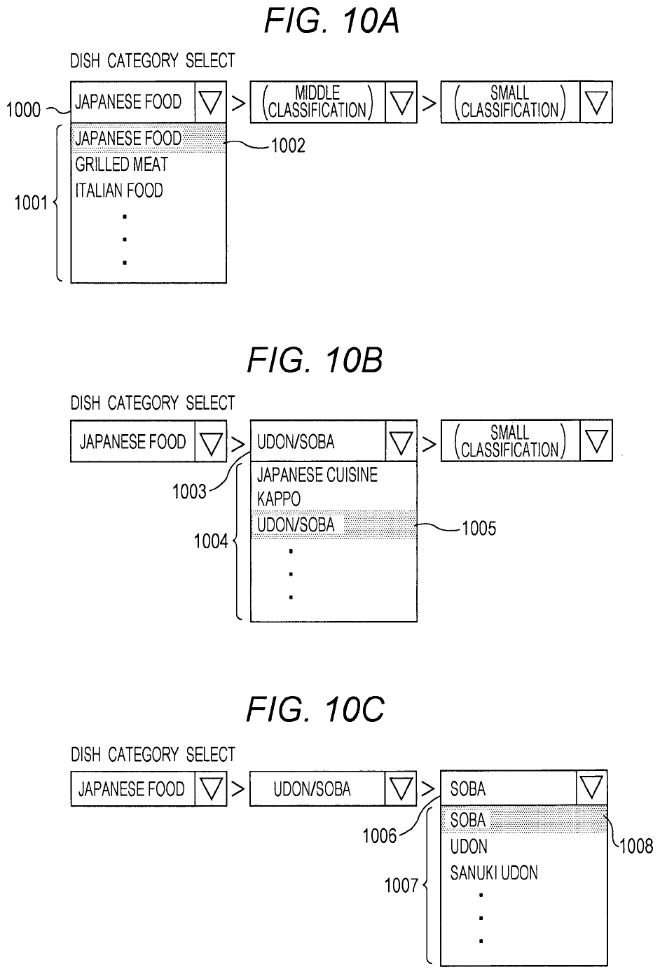

Each of the category selection drop-down lists 902 is a drop-down list for allowing a person concerned with a restaurant that provides the predetermined dish to select and input the category of the predetermined dish. Hereinafter, an example of a method of operating the category selection drop-down lists 902 will be described with reference to FIG. 10A to FIG. 10C.

FIG. 10A is a schematic view for illustrating an example of a method of operating a category large classification selection drop-down list 1000 that is included in the category selection drop-down lists 902.

As the category large classification selection drop-down list 1000 is specified by a person concerned with a restaurant that provides each dish, a category large classification list 1001 containing the pieces of text information of the classification items of the category large classification (“Japanese food”, “grilled meat”, “Italian food”, and the like) is displayed.

As any one of the pieces of text information of the classification items that are displayed in the category large classification list 1001 is selected by the person concerned with the restaurant that provides each dish, a category large classification cursor 1002 indicates the text information (for example, “Japanese food”) of the selected classification item. The text information (for example, “Japanese food”) of the classification item is displayed in the category large classification selection drop-down list 1000, and the category large classification list 1001 disappears.

FIG. 10B is a schematic view for illustrating an example of a method of operating a category middle classification selection drop-down list 1003 that is included in the category selection drop-down lists 902.

As the category middle classification selection drop-down list 1003 is specified by the person concerned with the restaurant that provides each dish, a category middle classification list 1004 containing the pieces of text information (“Japanese cuisine”, “kappo”, “udon/soba”, and the like) of the classification items of the category middle classification contained in the text information (for example, “Japanese food”) of the classification item of the category large classification, indicated by the category large classification cursor 1002, is displayed. When no classification item of the category middle classification is contained in the classification item of the category large classification, indicated by the category large classification cursor 1002, the category middle classification selection drop-down list 1003 and a category small classification selection drop-down list 1006 are controlled such that a selection operation is disabled.

As any one of the pieces of text information of the classification items displayed in the category middle classification list 1004 is selected by the person concerned with the restaurant that provides each dish, a category middle classification cursor 1005 indicates the text information (for example, “udon/soba”) of the selected classification item. The text information (for example, “udon/soba”) of the classification item is displayed in the category middle classification selection drop-down list 1003, and the category middle classification list 1004 disappears.

FIG. 10C is a schematic view for illustrating an example of a method of operating the category small classification selection drop-down list 1006 that is included in the category selection drop-down lists 902.

As the category small classification selection drop-down list 1006 is specified by the person concerned with the restaurant that provides each dish, a category small classification list 1007 containing pieces of text information (“soba”, “udon”, “Sanuki udon”, and the like) of the classification items of the category small classification contained in the text information (for example, “udon/soba”) of the classification item of the category middle classification, indicated by the category middle classification cursor 1005, is displayed. When no classification item of the category small classification is contained in the classification item of the category middle classification, indicated by the category middle classification cursor 1005, the category small classification selection drop-down list 1006 is controlled such that a selection operation is disabled.

As any one of the pieces of text information of the classification items that are displayed in the category small classification list 1007 is selected by the person concerned with the restaurant that provides each dish, a category small classification cursor 1008 indicates the text information (for example, “soba”) of the selected classification item. The text information (for example, “soba”) of the classification item is displayed in the category small classification selection drop-down list 1006, and the category small classification list 1007 disappears.

In this way, the text information of the classification item of any one of the category large classification, the category middle classification and the category small classification is selected through selection input with the use of the category selection drop-down lists 902.

Referring back to FIG. 9, the detailed explanation display box 903 is a text box for displaying a detailed explanation corresponding to a category selected and input through the category selection drop-down lists 902. That is, when a category is selected and input through the category selection drop-down lists 902, the identification information of the selected category is transmitted to the server 2. Subsequently, in the server 2, the detailed explanation associated with the category identified on the basis of the transmitted identification information is extracted from the detailed explanation dictionary table. The extracted detailed explanation is transmitted from the server 2 to the intended shop terminal 3, and the received detailed explanation is displayed in the detailed explanation display box 903.

The detailed explanation change button 904 is a button for displaying a detailed explanation edit page 1100 for editing the detailed explanation displayed in the detailed explanation display box 903. The detailed explanation displayed in the detailed explanation display box 903 is general category explanatory text stored in the detailed explanation dictionary table in advance. The detailed explanation change button 904 is selected (depressed) by a person concerned with a restaurant when the person concerned with the restaurant intends to change the expression or content of the detailed explanation. As the detailed explanation change button 904 is selected (depressed), a request to display the detailed explanation edit page is transmitted to the server 2, and the detailed explanation edit page 1100 is displayed on the basis of page display data transmitted from the server 2. Thus, the general category explanatory text is allowed to be changed.

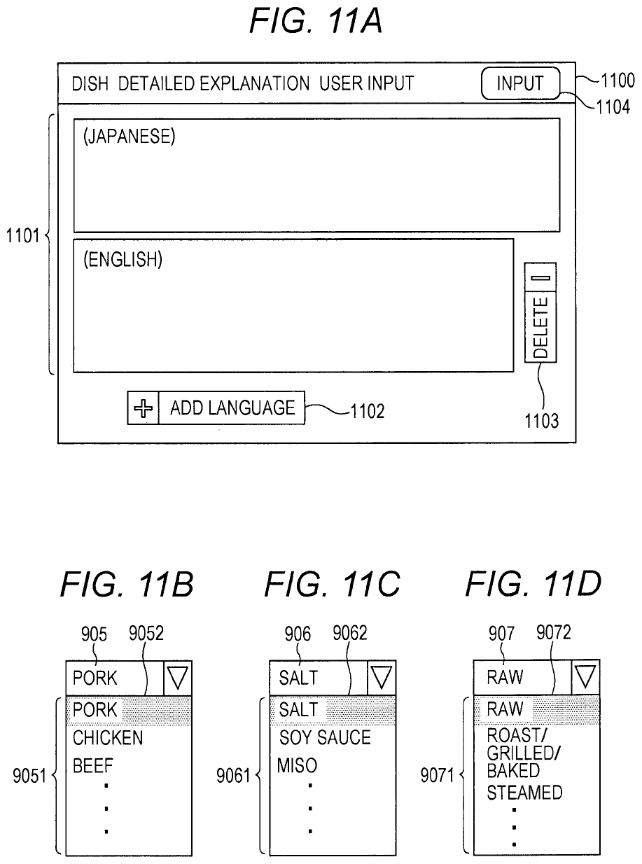

FIG. 11A is a view that shows an example of the detailed explanation edit page 1100 that is displayed on each shop terminal 3.

The detailed explanation edit page 1100 is a page that is displayed on the basis of image display data transmitted from the server 2 when the detailed explanation change button 904 displayed on the registration page 900 has been selected (depressed) by a person concerned with a restaurant. Detailed explanation edit boxes 1101, an edit box addition button 1102, an edit box deletion button 1103, an edit completion button 1104, and the like, are displayed on the detailed explanation edit page 1100.

The detailed explanation edit boxes 1101 are text input boxes for editing the text information of the detailed explanation displayed in the detailed explanation display box 903. The detailed explanation edit boxes 1101 are displayed in correspondence with the detailed explanation in the first language and the detailed explanation in the second language. At the time when the detailed explanation edit page 1100 is displayed, the text information of the detailed explanation displayed in the detailed explanation display box 903 is displayed in the detailed explanation edit box 1101 corresponding to the detailed explanation in the first language. The person concerned with the restaurant is allowed to edit the text information of the detailed explanation displayed in the detailed explanation edit boxes 1101 by operating the shop terminal operation unit 33. The text information that the detailed explanation displayed in the detailed explanation display box 903 is written in the second language is displayed on the basis of the detailed explanation dictionary table in the detailed explanation edit box 1101 corresponding to the detailed explanation in the second language.

The edit box addition button 1102 is an input button for adding a detailed explanation edit box 1101 for editing the text information of a detailed explanation in another language. As the edit box addition button 1102 is selected (depressed) by the person concerned with the restaurant, an editing language is selected by the person concerned with the restaurant from among multiple languages through a language selection page (not shown), and the detailed explanation edit box 1101 for editing the text information of the detailed explanation in the selected language is displayed.

The edit box deletion button 1103 is an input button for deleting the displayed detailed explanation edit box 1101 for each language. The edit box deletion button 1103 corresponding to each language is displayed near the detailed explanation edit box 1101 corresponding to the detailed explanation in the language. As the edit box deletion button 1103 is selected (depressed) by the person concerned with the restaurant, the detailed explanation edit box 1101 corresponding to the selected edit box deletion button 1103 is deleted.

As the edit completion button 1104 is selected (depressed), the detailed explanation edit page 1100 disappears, and the detailed explanation in the first language, provided in the detailed explanation edit box 1101, is displayed in the detailed explanation display box 903 on the registration page 900. The detailed explanation in a language other than the first language, provided in the detailed explanation edit box 1101, is temporarily stored in the shop terminal storage unit 32.

Referring back to FIG. 9, the ingredient selection drop-down list 905 is a drop-down list for selecting and inputting an ingredient that is used for the predetermined dish. Hereinafter, an example of a method of operating the ingredient selection drop-down list 905 will be described with reference to FIG. 11B.

As the ingredient selection drop-down list 905 is specified by the person concerned with the restaurant, an ingredient list 9051 containing ingredient names stored in the ingredient table is displayed. Subsequently, as any one of the ingredient names displayed in the ingredient list 9051 is selected, the selected ingredient name (for example, “pork”) is indicated by an ingredient selection cursor 9052. The selected ingredient name is displayed in the ingredient selection drop-down list 905, and the ingredient list 9051 disappears.

Referring back to FIG. 9, the seasoning selection drop-down list 906 is a drop-down list for selecting and inputting a seasoning that is used for the predetermined dish. Hereinafter, an example of a method of operating the seasoning selection drop-down list 906 will be described with reference to FIG. 11C.

As the seasoning selection drop-down list 906 is specified by the person concerned with the restaurant, a seasoning list 9061 containing seasoning names stored in the seasoning table is displayed. As any one of the seasoning names displayed in the seasoning list 9061 is selected, the selected seasoning name (for example, “salt”) is indicated by a seasoning selection cursor 9062. The selected seasoning name is displayed in the seasoning selection drop-down list 906, and the seasoning list 9061 disappears.

Referring back to FIG. 9, the cooking style selection drop-down list 907 is a drop-down list for selecting and inputting a cooking style that is used for the predetermined dish. Hereinafter, an example of a method of operating the cooking style selection drop-down list 907 will be described with reference to FIG. 11D.

As the cooking style selection drop-down list 907 is specified by the person concerned with the restaurant, a cooking style list 9071 containing cooking style names stored in the cooking style table is displayed. As any one of the cooking style names displayed in the cooking style list 9071 is selected, the selected cooking style name (for example, “raw”) is indicated by a cooking style selection cursor 9072. The selected cooking style name is displayed in the cooking style selection drop-down list 907, and the cooking style list 9071 disappears.

Referring back to FIG. 9, as the registration button 908 is depressed (selected) by the user, a registration request is transmitted to the server 2. The registration request contains information input to the dish name input boxes 901 in text, pieces of information respectively input to the category selection drop-down lists 902, the detailed explanation display box 903, the ingredient selection drop-down list 905, the seasoning selection drop-down list 906 and the cooking style selection drop-down list 907 for the predetermined dish, and the restaurant ID of the restaurant that provides the predetermined dish. The server 2 stores various pieces of information contained in the received registration request as menu item information. When a detailed explanation in a language other than the first language is temporarily stored in the shop terminal storage unit 32, the detailed explanation in the language other than the first language is contained in the registration request.

### Schematic Configuration of Mobile Terminal 4

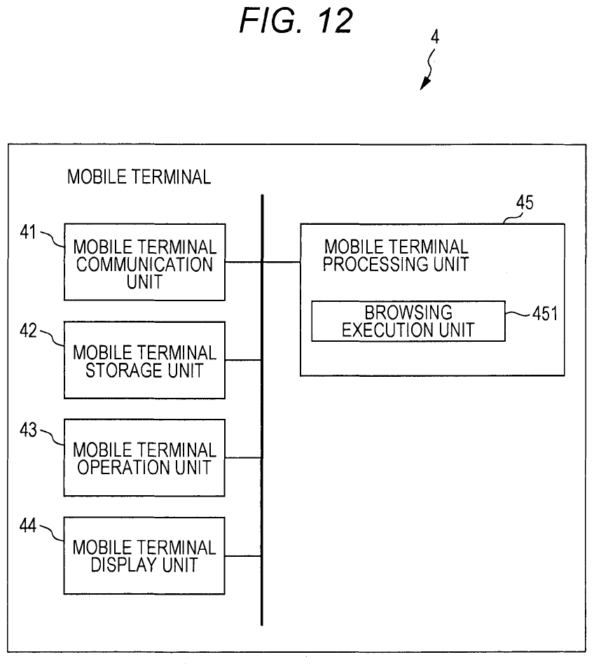

FIG. 12 is a view that shows an example of the schematic configuration of each mobile terminal 4.

Each mobile terminal 4 is connected to the server 2 via the base station 5, the mobile communication network 6, the gateway 7 and the Internet 8, and carries out communication with the server 2. Each mobile terminal 4 requires the server 2 to display menu item information, or the like, in response to user's operation on a mobile terminal operation unit 43 (button, or the like). Each mobile terminal 4 receives display data regarding menu item information, or the like, from the server 2, and displays the menu item information, or the like. For this reason, each mobile terminal 4 includes a mobile terminal communication unit 41, a mobile terminal storage unit 42, the mobile terminal operation unit 43, a mobile terminal display unit 44 and a mobile terminal processing unit 45.

In the present embodiment, a multifunctional mobile phone (so-called smartphone) is assumed as each mobile terminal 4; however, the present disclosure is not limited to employing a multifunctional mobile phone as each mobile terminal 4. Each mobile terminal 4 may be any terminal to which the present disclosure is applicable. Each mobile terminal 4 may be, for example, a mobile phone (so-called feature phone), a mobile information terminal (personal digital assistant (PDA)), a portable game machine, a portable audio player, a tablet terminal, a tablet PC, a notebook PC, or the like. Each mobile terminal 4 may be one of a plurality of menu terminals that are installed at a restaurant and with which customers at the restaurant order menu items, or the like.

The mobile terminal communication unit 41 includes a communication interface circuit including an antenna that uses a predetermined frequency band as a sensitive band. The mobile terminal communication unit 41 connects the corresponding mobile terminal 4 to a wireless communication network. The mobile terminal communication unit 41 establishes a wireless signal line with the base station 5 via a channel allocated by the base station 5 on the basis of code division multiple access (CDMA) system, or the like, and carries out communication with the base station 5. The mobile terminal communication unit 41 transmits data, supplied from the mobile terminal processing unit 45, to the server 2, or the like. The mobile terminal communication unit 41 supplies data, received from the server 2, or the like, to the mobile terminal processing unit 45.

The mobile terminal storage unit 42 includes, for example, a semiconductor memory device. The mobile terminal storage unit 42 stores an operating system program, a driver program, an application program, data, and the like, that are used for processing in the mobile terminal processing unit 45. For example, the mobile terminal storage unit 42 stores an input device driver program that controls the mobile terminal operation unit 43, an output device driver program that controls the mobile terminal display unit 44, and the like, as the driver program. The mobile terminal storage unit 42 stores a program, or the like, that acquires and displays display data regarding menu item information, or the like, as the application program. The mobile terminal storage unit 42 may temporarily store temporary data associated with predetermined processing.

The mobile terminal operation unit 43 may be any device as long as the mobile terminal 4 is operable by using the mobile terminal operation unit 43, and is, for example, a touch panel, a key button, or the like. The user is allowed to input characters, numerics, symbols, and the like, with the mobile terminal operation unit 43. As the mobile terminal operation unit 43 is operated by the user, the mobile terminal operation unit 43 generates a signal corresponding to the operation. The generated signal is supplied to the mobile terminal processing unit 45 as a command from the user.

The mobile terminal display unit 44 may also be any device as long as the mobile terminal display unit 44 is able to display video, an image, and the like. The mobile terminal display unit 44 may be, for example, a liquid crystal display, an organic electro-luminescence (EL) display, or the like. The mobile terminal display unit 44 displays video based on video data, an image based on image data, or the like, supplied from the mobile terminal processing unit 45.

The mobile terminal processing unit 45 includes one or plurality of processors and their peripheral circuit. The mobile terminal processing unit 45 is to generally control the overall operations of the corresponding mobile terminal 4. The mobile terminal processing unit 45 is, for example, a CPU. The mobile terminal processing unit 45 controls the operations of the mobile terminal communication unit 41, mobile terminal display unit 44, and the like, such that the corresponding mobile terminal 4 executes various processing in an appropriate procedure on the basis of the programs that are stored in the mobile terminal storage unit 42, an operation on the mobile terminal operation unit 43, and the like. The mobile terminal processing unit 45 executes processing on the basis of the programs, such as the operating system program, the driver program and the application program, that are stored in the mobile terminal storage unit 42. The mobile terminal processing unit 45 is able to execute a plurality of programs (application programs, or the like) in parallel.

The mobile terminal processing unit 45 includes at least a browsing execution unit 451. The browsing execution unit 451 is a functional module that is implemented by a program that is executed by the processor(s) of the mobile terminal processing unit 45. Alternatively, the browsing execution unit 451 may be implemented in each mobile terminal 4 as firmware and/or processing circuitry for performing different functions requested by a user of the mobile terminal 4.

The browsing execution unit 451 acquires and displays display data regarding menu item information, or the like. That is, the browsing execution unit 451 transmits a request to display a page associated with menu item information to the server 2 via the mobile terminal communication unit 41 in response to a command from the user. The browsing execution unit 451 receives corresponding display data from the server 2 via the mobile terminal communication unit 41. The browsing execution unit 451 creates drawing data on the basis of the received display data. That is, the browsing execution unit 451 analyzes the received display data, identifies control data and content data, layouts the identified content data on the basis of the identified control data, and creates drawing data. The browsing execution unit 451 outputs the created drawing data to the mobile terminal display unit 44.

Functions of Mobile Terminal 4

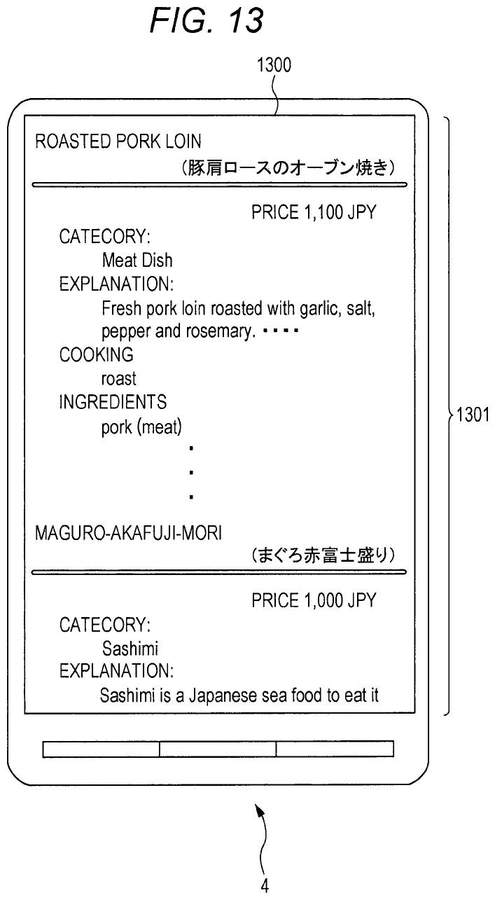

FIG. 13 is a view that shows an example of a menu item information display page 1300 that is displayed by the display function of each mobile terminal 4. With the display function of each mobile terminal 4, text information in any one of multiple languages is displayed. Hereinafter, description will be made on the assumption that the mobile terminal 4 shows text information in the second language (English) different from the first language (Japanese).

The menu item information of a menu, which introduces dishes that are provided at a restaurant selected by the user, is displayed on the menu item information display page 1300. The menu item information display page 1300 is, for example, a page that is transmitted from the server 2, and is a page linked with a homepage that introduces restaurants placed on a predetermined information providing site.

In the example of the menu item information display page 1300 shown in FIG. 13, a menu item introduction 1301, and the like, are displayed as menu item information. The menu item introduction 1301 contains a dish name, and the category, menu item properties, detailed explanation, and the like, of the dish. The menu item introduction 1301 is created by extracting a dish name and dish information, associated with a restaurant ID of a restaurant selected by the user on the predetermined information providing site, from the menu item information table. The menu item information display page 1300 is displayed on the basis of page display data containing the created menu item introduction 1301.

The language to show the menu item introduction 1301 is a language set to be displayed by the mobile terminal 4. At the time when the mobile terminal 4 requires the menu item information display page 1300 from the server 2, the mobile terminal 4 transmits language specification information to the server 2. The language specification information is information for specifying the language in which the text information is shown on the mobile terminal 4. The server 2 extracts a dish name and dish information from the menu item information table on the basis of the language specification information, and creates the menu item introduction 1301.

### Example 1 of Operation Sequence of Menu Generation System 1

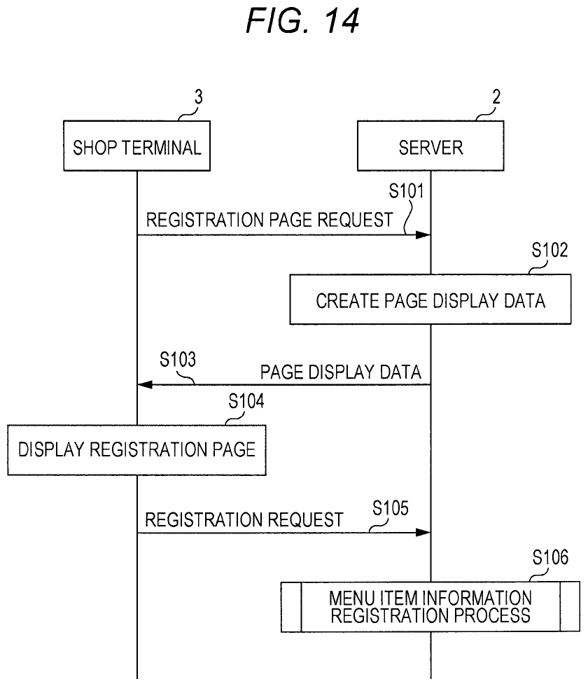

FIG. 14 is a view that shows an example of the operation sequence of the menu generation system 1. This operation sequence is executed by mainly the server processing unit 23 and the shop terminal processing unit 35 in cooperation with the elements of the server 2 and shop terminal 3 on the basis of programs stored in the server storage unit 22 and the shop terminal storage unit 32 in advance.

First, the terminal transmission unit 352 of the shop terminal 3 of a person concerned with a restaurant transmits a registration page request containing a restaurant ID to the server 2 via the shop terminal communication unit 31 in response to an operation on the shop terminal operation unit 33, which is carried out by the person concerned with the restaurant, or the like (step S101).

Subsequently, as the page creating unit 231 of the server 2 receives the registration page request from the shop terminal 3 via the server communication unit 21, the page creating unit 231 creates page display data for displaying the registration page 900 (step S102). Initially, the page creating unit 231 creates the category selection drop-down lists 902 on the basis of the category table. Subsequently, the page creating unit 231 creates the ingredient selection drop-down list 905 on the basis of the ingredient table. After that, the page creating unit 231 creates the seasoning selection drop-down list 906 on the basis of the seasoning table. Then, the page creating unit 231 creates the cooking style selection drop-down list 907 on the basis of the cooking style table. The page creating unit 231 creates page display data for displaying the registration page 900 containing the created category selection drop-down lists 902, ingredient selection drop-down list 905, seasoning selection drop-down list 906 and cooking style selection drop-down list 907.

Subsequently, the server transmission unit 235 of the server 2 transmits the created page display data for displaying the registration page 900 to the shop terminal 3, corresponding to the received restaurant ID, via the server communication unit 21 (step S103).

Subsequently, as the browsing execution unit 351 of the shop terminal 3 receives the page display data for displaying the registration page 900 from the server 2 via the shop terminal communication unit 31, the browsing execution unit 351 displays the registration page 900 on the shop terminal display unit 34 on the basis of the received page display data (step S104).

Subsequently, the browsing execution unit 351 of the shop terminal 3 transmits a registration request to the server 2 via the shop terminal communication unit 31 (step S105). The registration request contains input information and the restaurant ID. The input information is input through an operation on the shop terminal operation unit 33 by the person concerned with the restaurant, or the like, on the registration page 900 displayed on the shop terminal display unit 34.

The input processing unit 232, conversion processing unit 233 and storage processing unit 234 of the server 2 execute menu item information registration process on the basis of various pieces of information contained in the registration request received via the server communication unit 21 (step S106). The details of the menu item information registration process will be described later.

### Menu Item Information Registration Process

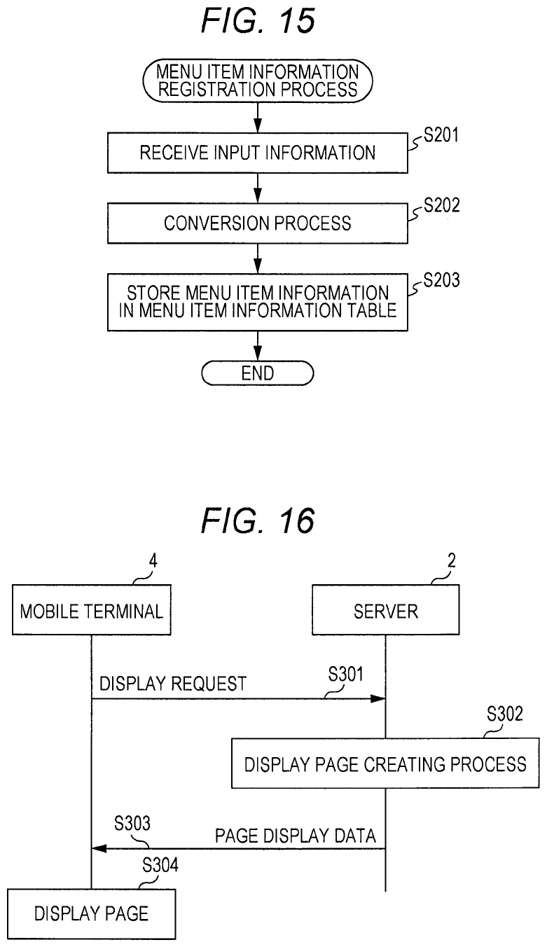

FIG. 15 is a flowchart that shows an example of the menu item information registration process. The menu item information registration process shown in FIG. 15 is executed in step S106 of FIG. 14.

Initially, the input processing unit 232 receives a registration request from the shop terminal 3 (step S201). The registration request contains the restaurant ID, the pieces of text information of the dish name in multiple languages, input in text respectively to the dish name input boxes 901, the text information of the category, selected and input for the predetermined dish, the pieces of text information of the menu item properties, selected and input for the predetermined dish, and the text information of the detailed explanation, displayed in the detailed explanation display box 903. The menu item properties contain the text information of the ingredient, selected and input through the ingredient selection drop-down list 905, the text information of the seasoning, selected and input through the seasoning selection drop-down list 906, and the text information of the cooking style, selected and input through the cooking style selection drop-down list 907. When a detailed explanation in a language other than the first language is temporarily stored in the shop terminal storage unit 32 at the time of a registration request, the registration request contains the detailed explanation in the language other than the first language.

Subsequently, the conversion processing unit 233 converts the received pieces of text information of the category, menu item properties and detailed explanation to pieces of text information of the category, menu item properties and detailed explanation in a language different from the language of the received text information (step S202). Hereinafter, a conversion process that is executed by the conversion processing unit 233 will be described.

Initially, the conversion processing unit 233 identifies the received pieces of text information of the category and menu item properties, the received text information of the detailed explanation, and the language of the received text information. Subsequently, the conversion processing unit 233 consults the term dictionary table, and extracts pieces of text information in a language different from the identified language, associated with the identified pieces of text information of the category and menu item properties, as translated text information.

When a plurality of pieces of text information of a cooking style in the second language have been extracted from among the received menu item properties, the conversion processing unit 233 executes the process of specifying text information in the second language. Initially, the conversion processing unit 233 identifies the extracted text information of the ingredient in the second language among the received menu item properties. Subsequently, the conversion processing unit 233 consults the property related table, and extracts the text information of the cooking style in the second language, associated with the identified text information of the ingredient in the second language. The conversion processing unit 233 identifies the text information of the cooking style in the second language, identified by consulting the property related table, from among the plurality of extracted pieces of cooking styles in the second language, as the translated text information. Thus, the identification process ends. In the case where pieces of text information of ingredients in a predetermined language and pieces of text information of seasonings in the predetermined language are stored in the property related table in association with each other, or in the case where pieces of text information of cooking styles and pieces of text information of seasonings are stored in the property related table in association with each other, when a plurality of pieces of text information of ingredients or seasonings in the predetermined language are extracted, the above-described identification process is executed.

Subsequently, the conversion processing unit 233 consults the detailed explanation dictionary table, and extracts the text information of the detailed explanation in a language different from the identified language, associated with the identified text information of the detailed explanation, as the translated text information. When the registration request contains a detailed explanation in a language other than the first language, the conversion processing unit 233 extracts the detailed explanation contained in the registration request as the translated text information without consulting the term dictionary table. Thus, the conversion process ends. The conversion processing unit 233 is an example of an extracting unit.

The storage processing unit 234 stores the received text information of the dish name of the dish, the received restaurant ID, the received pieces of text information of the category and menu item properties of the dish, the received text information of the detailed explanation, the extracted text information of the category, the extracted pieces of translated text information of the menu item properties, and the extracted translated text information of the detailed explanation in the menu item information table as menu item information in association with a new dish ID (step S203), after which a series of steps ends.

### Example 2 of Operation Sequence of Menu Generation System 1

FIG. 16 is a view that shows an example of the operation sequence of the menu generation system 1. This operation sequence is executed by mainly the server processing unit 23 and the mobile terminal processing unit 45 in cooperation with the elements of the server 2 and mobile terminal 4 on the basis of programs stored in the server storage unit 22 and the mobile terminal storage unit 42 in advance.

The browsing execution unit 451 of the mobile terminal 4 of the user transmits a display request to the server 2 via the mobile terminal communication unit 41 in response to an operation of the user (a user (customer) of a restaurant, or the like) on the mobile terminal operation unit 43 (step S301). The display request contains a restaurant ID and language specification information. A display request is transmitted when a link (a link for displaying menu items, or the like) contained in a homepage that introduces restaurants placed on the predetermined information providing site is specified by the user.

Subsequently, as the page creating unit 231 of the server 2 receives the display request from the mobile terminal 4 via the server communication unit 21, the page creating unit 231 executes display page creating process (step S302). Initially, the page creating unit 231 identifies a restaurant ID and language specification information, contained in the display request. Subsequently, the page creating unit 231 consults the menu item information table, and extracts a dish name and dish information, corresponding to the identified language specification information, from among the dish names and the pieces of dish information, associated with the identified restaurant ID. Subsequently, the page creating unit 231 creates the menu item introduction 1301 on the basis of the extracted information. The page creating unit 231 creates page display data for displaying the menu item information display page 1300 containing the menu item introduction 1301.

Subsequently, the server transmission unit 235 of the server 2 transmits the page display data for displaying the menu item information display page 1300 created through the display page creating process to the mobile terminal 4 via the server communication unit 21 (step S303).

As the browsing execution unit 451 of the mobile terminal 4 receives the page display data from the server 2 via the mobile terminal communication unit 41, the browsing execution unit 451 displays the menu item information display page 1300 on the mobile terminal display unit 44 on the basis of the received page display data (step S304).

As described in detail above, the menu generation system 1 is able to translate a term in a predetermined language into an appropriate term in another language.

### First Alternative Embodiment

Ingredients that are stored in the ingredient table, seasonings that are stored in the seasoning table, or cooking styles that are stored in the cooking style table, may have a tree structure with a plurality of levels.

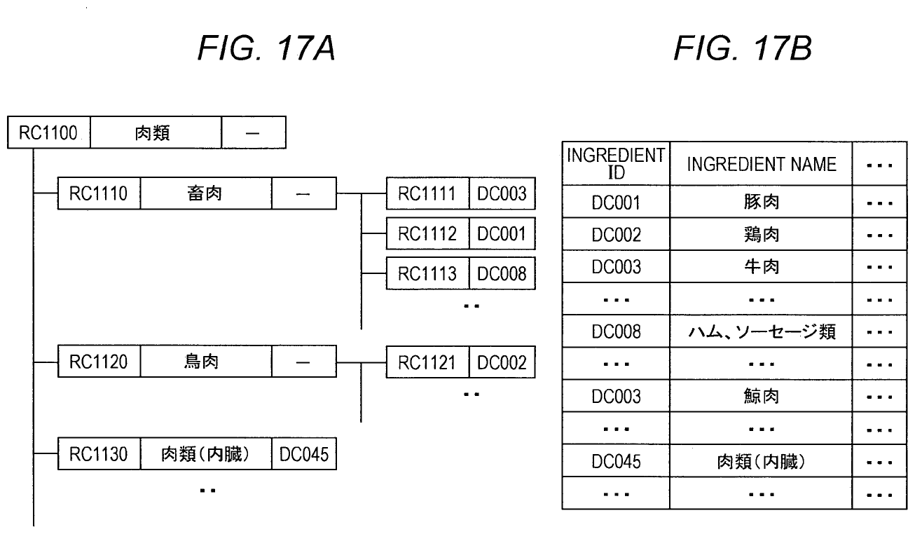

Hereinafter, the tree structure of ingredients will be described with reference to FIG. 17A that shows a schematic view for illustrating an example of the tree structure of ingredients and FIG. 17B that shows a view that shows another example of the data structure of an ingredient table.

In the tree structure, one or plurality of first-level nodes are associated as child nodes of a predetermined root node, and one or plurality of second-level nodes are further associated as child nodes of each first-level node.

As shown in FIG. 17A, for example, an item “ [symbol] ” is stored as a root node in association with node identification information “RC1100”. In the “ [symbol] ”, items “ [symbol] ” “ [symbol] ”, “ [symbol] ”, and the like, are stored as child nodes in association with pieces of node identification information “RC1110”, “RC1120”, “RC1130”, and the like, respectively. The node identification information is identification information for identifying each node in the tree structure.

In the item “ [symbol] ”, ingredient IDs “DC003”, “DC001”, “DC008”, and the like, are stored as child nodes in association with pieces of node identification information “RC1111”, “RC1112”, “RC1113”, and the like, respectively. By consulting the ingredient table shown in FIG. 17B, “DC003” indicates “ [symbol] ”, “DC001” indicates “ [symbol] ”, and “DC008” indicates “ [symbol] ”.

In the item “ [symbol] ”, an ingredient ID “DC002”, and the like, are stored as child nodes in association with node identification information “RC1121”, and the like. By consulting the ingredient table shown in FIG. 17B, “DC002” indicates “ [symbol] ”.

When an item is stored in the ingredient table as a root node or a first-level node, an ingredient ID is stored in association with node identification information. In the example of the tree structure of ingredients, shown in FIG. 17A, the ingredient ID “DC045” is stored in association with the node identification information “RC1130” of the item “ [symbol] ” that is the first-level node.

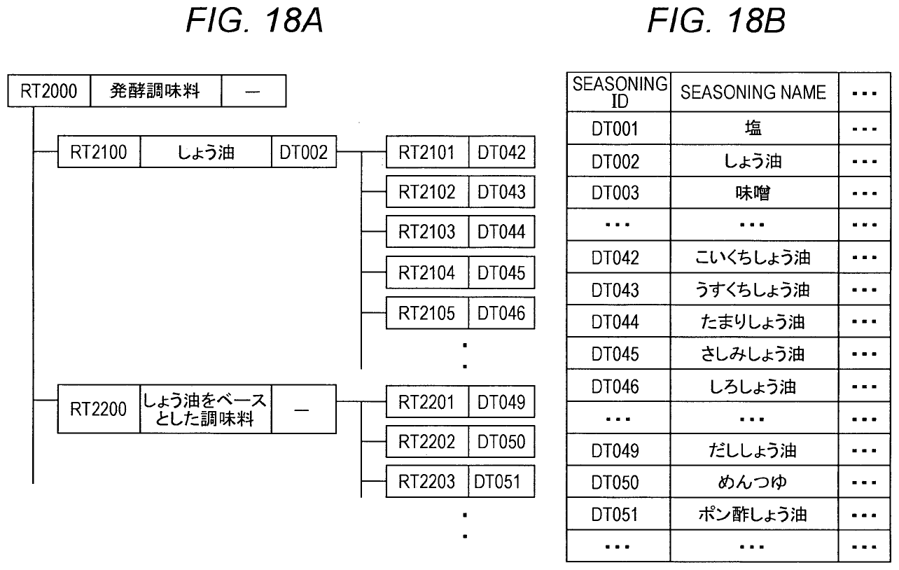

Next, the tree structure of seasonings will be described with reference to FIG. 18A that shows a schematic view for illustrating an example of the tree structure of seasonings and FIG. 18B that shows a view that shows another example of the data structure of a seasoning table.

As shown in FIG. 18A, for example, an item “ [symbol] ” is stored as a root node in association with node identification information “RT2000”. In the “ [symbol] [symbol] ”, items “ [symbol] ”, “ [symbol] [symbol] ”, and the like, are stored as child nodes in association with pieces of node identification information “RT2100”, “RT2200”, and the like, respectively.

In the item “ [symbol] ”, seasoning IDs “DT042”, “DT043”, “DT044”, “DT045”, “DT046”, and the like, are stored as child nodes in association with pieces of node identification information “RT2101”, “RT2102”, “RT2103”, “RT2104”, “RT2105”, and the like, respectively. By consulting the seasoning table shown in FIG. 18B, “DT042” indicates “ [symbol] ”, “DT043” indicates “ [symbol] ”, “DT044” indicates “ [symbol] ”, “DT045” indicates “ [symbol] ”, and “DT046” indicates “ [symbol] ”.

In the item “ [symbol] [symbol] ”, seasoning IDs “DT049”, “DT050”, “DT051”, and the like, are stored as child nodes in association with pieces of node identification information “RT2201”, “RT2202”, “RT2203”, and the like, respectively. By consulting the seasoning table shown in FIG. 18B, “DT049” indicates “ [symbol] ”, “DT050” indicates “ [symbol] ”, and “DT051” indicates “ [symbol] ”.

When an item is stored in the seasoning table as a root node or a first-level node, a seasoning ID is stored in association with node identification information. In the example of the tree structure of seasonings, shown in FIG. 18A, the seasoning ID “DT002” is stored in association with the node identification information “RT2100” of the item “ [symbol] [symbol] ” that is the first-level node.

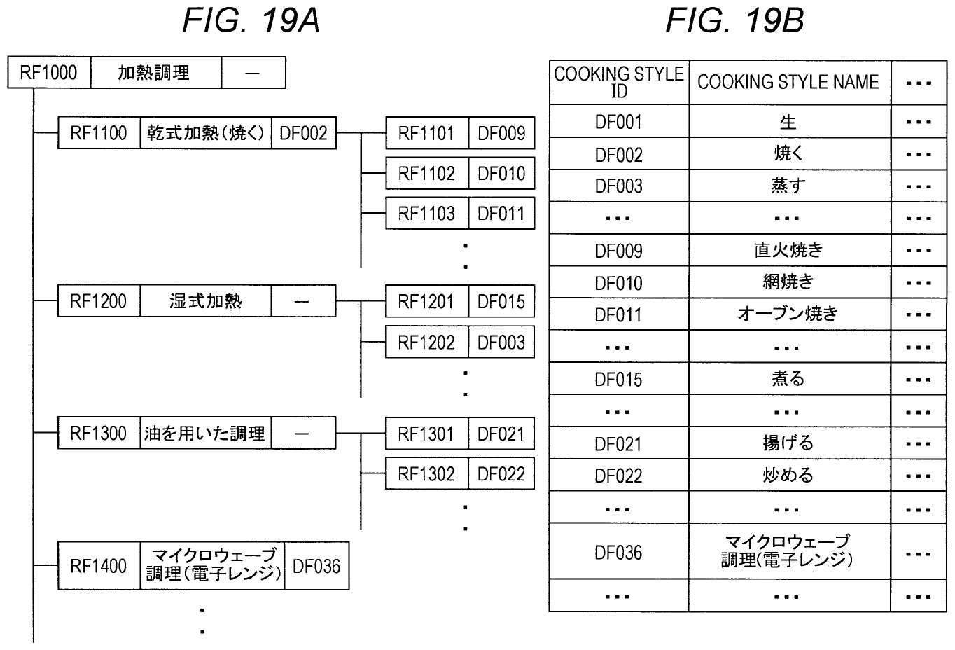

Next, the tree structure of cooking styles will be described with reference to FIG. 19A that shows a schematic view for illustrating an example of the tree structure of cooking styles and FIG. 19B that shows a view that shows another example of the data structure of a cooking style table.

As shown in FIG. 19A, for example, an item “ [symbol] ” is stored as a root node in association with node identification information “RF1000”. In the “ [symbol] [symbol] ”, items “ [symbol] )”, “ [symbol] ”, “ [symbol] ”, “ [symbol] [symbol] [symbol] ”, and the like, are stored as child nodes in association with pieces of node identification information “RF1100”, “RF1200”, “RF1300”, “RF1400”, and the like, respectively.

In the item “ [symbol] ”, cooking style IDs “DF009”, “DF010”, “DF011”, and the like, are stored as child nodes in association with pieces of node identification information “RF1101”, “RF1102”, “RF1103, and the like, respectively. By consulting the cooking style table shown in FIG. 19B, “DF009” indicates “ [symbol] ”, “DF010” indicates “ [symbol] ”, and “DF011” indicates “ [symbol] ”.

In the item “ [symbol] ”, cooking style IDs “DF015”, “DF003”, and the like, are stored as child nodes in association with pieces of node identification information “RF1201”, “RF1202”, and the like, respectively. By consulting the cooking style table shown in FIG. 19B, “DF015” indicates “ [symbol] ”, and “DF003” indicates “ [symbol] ”.

In the item “ [symbol] ”, cooking style IDs “DF021”, “DF022”, and the like, are stored as child nodes in association with pieces of node identification information “RF1301”, “RF1302”, and the like, respectively. By consulting the cooking style table shown in FIG. 19B, “DF021” indicates “ [symbol] ”, and “DF022” indicates “ [symbol] [symbol] ”.

When an item is stored in the cooking style table as a root node or a first-level node, a cooking style ID is stored in association with node identification information. In the example of the tree structure of cooking styles, shown in FIG. 19A, the cooking style ID “DF002” is stored in association with the node identification information “RF1100” of the item “ [symbol] ” that is the first-level node. The cooking style ID “DF036” is stored in association with the node identification information “RF1400” of the item “ [symbol] [symbol] ” that is the first-level node.

In the schematic views shown in FIG. 17A to FIG. 19B, description is made by taking the tree structure with a root node, first-level nodes and second-level nodes as an example. Instead, a third or lower-level node may be included as a node contained in the tree structure. The schematic views shown in FIG. 17A to FIG. 19B are used to describe the tree structures of menu item properties in Japanese. Instead, menu item properties in a language other than Japanese may have tree structures with a plurality of levels.

The names of ingredients having a tree structure with a plurality of levels, shown in FIG. 17A, are displayed in the ingredient list 9051 of the ingredient selection drop-down list 905. The names of seasonings having a tree structure with a plurality of levels, shown in FIG. 18A, are displayed in the seasoning list 9061 of the seasoning selection drop-down list 906. The names of cooking styles having a tree structure with a plurality of levels, shown in FIG. 19A, are displayed in the cooking style list 9071 of the cooking style selection drop-down list 907. Thus, an ingredient selected by using the ingredient selection drop-down list 905, a seasoning selected by using the seasoning selection drop-down list 906 and a cooking style selected by using the cooking style selection drop-down list 907 are stored in the menu item information table by the storage processing unit 234.

### Second Alternative Embodiment

The shop terminal storage unit 32 of each shop terminal 3 and/or the mobile terminal storage unit 42 of each mobile terminal 4 may store all or part of the category table, the ingredient table, the seasoning table, the cooking style table, the restaurant table, the term dictionary table, the property related table, the detailed explanation dictionary table and the menu item information table. In this case, at the time when the server 2 uses pieces of information stored in these various tables, the server 2 accesses the shop terminal storage unit 32 of the shop terminal 3 and/or the mobile terminal storage unit 42 of the mobile terminal 4, acquires pieces of information stored in the tables, and executes various processing.

### Third Alternative Embodiment

The menu generation system 1 may include only one or plurality of shop terminals 3. In this case, each shop terminal 3 has the functions of the server 2 and mobile terminal 4. The menu generation system 1 may include only one or plurality of mobile terminals 4. In this case, each mobile terminal 4 has the functions of the server 2 and shop terminal 3.

In this embodiment, a mobile terminal 4 associated with a user (i.e. user terminal) may detect a location of a user and download a restaurant menu associated with the detected location. For example, if a user walks into a restaurant, the user terminal may detect the location of the restaurant and determine that the user is in Restaurant A. Thereafter, the user terminal may download a menu associated with Restaurant A. At this point, there may be several ways by which the user terminal can output a translated menu according to the user preferred language. In one example, the user terminal may download the menu and associated menu item information tables from server 2 and perform the conversion processing at the user terminal using the menu item information tables. In another example, the user terminal may capture an image of the menu of Restaurant A and based on the captured image, identify the restaurant as Restaurant A and download the menu and associated menu item information tables from server 2 and perform the conversion processing as above. In yet another example, the user terminal may communicate with a shop terminal and download the necessary information. For example, the mobile terminal may communicate with the shop terminal using a wireless technology, such as WiFi, Bluetooth®, Infrared, or other means of near-field communications.

The above disclosure also encompasses the embodiments listed below.

(1) A menu generation system that generates a menu of a restaurant in multiple languages, the menu generation system comprising:

a memory that stores a first menu item property in a first language and a plurality of first menu item properties in a second language in association with each other and that stores each of the plurality of first menu item properties in the second language and a second menu item property in association with each other;

processing circuitry that
receives a selected and input first menu item property from a user terminal in the first language and a selected and input second menu item property for a predetermined dish from among menu item properties stored in the memory, the first language being based on a setting of the user terminal,
extracts the first menu item property in the second language, stored in the memory in association with the received second menu item property, from among the plurality of first menu item properties in the second language, stored in the memory in association with the received first menu item property in the first language, and
transmits, to a user terminal, the extracted first menu item property in the second language for the predetermined dish.

(2) The menu generation system according to claim 1, wherein:

the second menu item properties have a tree structure with a plurality of levels including a primary level node relating to one or more second menu item properties associated with lower levels than the primary level,

the memory stores a property value of each second menu item property that belongs to any one of the plurality of levels and a property value of a corresponding one of the first menu item properties in association with each other, and

the processing circuitry
identifies a second menu item as the primary level node,
extracts the primary level node and one or more second menu item properties in the one or more lower levels, and
transmits the extracted primary level node and the one or more second menu item properties to the user terminal.

(3) The menu generation system according to claim 2, wherein:

the first menu item property is a cooking style, and

the second menu item property is an ingredient.

(4) The menu generation system according to claim 3, wherein the user terminal is configured to display the extracted information in a menu setting in the second language.

(5) The menu generation system according to claim 2, wherein:

the first menu item property is an ingredient, and

the second menu item property is a cooking style.

(6) The menu generation system according to claim 1, wherein:

the first menu item properties have a tree structure with a plurality of levels, and

the second menu item properties have a tree structure with a plurality of levels.

(7) The menu generation system according to claim 6, wherein the memory stores each of the plurality of first menu item properties in the first language and a second menu item property in association with each other.

(8) The menu generation system according to claim 1, wherein the setting of the user terminal includes a location based setting based on a location of the user terminal at a particular point in time.

(9) A menu generation method that is executed by a computer, the computer including a memory, the computer including processing circuitry being configured to generate a menu of a restaurant in one or more languages, the menu generation method comprising:

storing a first menu item property in a first language and a plurality of first menu item properties in a second language in the memory in association with each other and storing each of the plurality of first menu item properties in the second language and a second menu item property in the memory in association with each other;

receiving a selected and input first menu item property in the first language and a selected and input second menu item property for a predetermined dish from among menu item properties stored in the memory;

extracting the first menu item property in the second language, stored in the memory in association with the received second menu item property, from among the plurality of first menu item properties in the second language, stored in the memory in association with the received first menu item property in the first language; and

transmitting, to a user terminal, the extracted first menu item property in the second language for the predetermined dish.

(10) A non-transitory computer-readable storage medium storing a menu generation program, the menu generation program which when executed by a computer of an information processing system causing the computer, including a memory and configured to generate a menu of a restaurant in one or more languages, to perform a menu generation method, the menu generation method comprising:

storing a first menu item property in a first language and a plurality of first menu item properties in a second language in the memory in association with each other and storing each of the plurality of first menu item properties in the second language and a second menu item property in the memory in association with each other;

receiving a selected and input first menu item property in the first language and a selected and input second menu item property for a predetermined dish from among menu item properties stored in the memory;

extracting the first menu item property in the second language, stored in the memory in association with the received second menu item property, from among the plurality of first menu item properties in the second language, stored in the memory in association with the received first menu item property in the first language; and

transmitting, to a user terminal, the extracted first menu item property in the second language for the predetermined dish.

Persons skilled in the art understand that various modifications, replacements and changes are allowed to be added to the above-described embodiments without departing from the spirit and scope of the present disclosure.

### DRAWINGS

FIG. 1
1/ FIRST MENU ITEM PROPERTY (COOKING STYLE) IN FIRST LANGUAGE
2/ FIRST MENU ITEM PROPERTY (COOKING STYLE) IN SECOND LANGUAGE
3/ SECOND MENU ITEM PROPERTY (INGREDIENT) IN SECOND LANGUAGE
4/ MENU ITEM REGISTRATION
5/ REGISTER
6/ COOKING STYLE
7/ INGREDIENT

FIG. 3
2/ SERVER
21/ SERVER COMMUNICATION UNIT
22/ SERVER STORAGE UNIT
23/ SERVER PROCESSING UNIT
231/ PAGE CREATING UNIT
232/ INPUT PROCESSING UNIT
233/ CONVERSION PROCESSING UNIT
234/ STORAGE PROCESSING UNIT
235/ SERVER TRANSMISSION UNIT

FIG. 4A
1/ CATEGORY ID
2/ CATEGORY LARGE CLASSIFICATION
3/ CATEGORY MIDDLE CLASSIFICATION
4/ CATEGORY SMALL CLASSIFICATION
5/ DETAILED EXPLANATION
   (DETAILED EXPLANATION ID)
6/ CORRESPONDING MENU ITEM PROPERTIES
   (CORRESPONDING INGREDIENT ID, CORRESPONDING SEASONING ID, CORRESPONDING COOKING STYLE ID)
7/ JAPANESE FOOD
8/ JAPANESE CUISINE
9/ UDON/ SOBA
10/ SASHIMI
11/ SOBA

FIG. 4B
1/ INGREDIENT ID
2/ INGREDIENT NAME

FIG. 4C
1/ SEASONING ID
2/ SEASONING NAME

FIG. 4D
1/ COOKING STYLE ID
2/ COOKING STYLE NAME

FIG. 5A
1/ RESTAURANT ID
2/ NAME
   (IN FIRST LANGUAGE, IN SECOND LANGUAGE, . . . )
3/ ADDRESS
   (IN FIRST LANGUAGE, IN SECOND LANGUAGE, . . . )
4/ NEAREST STATION
   (IN FIRST LANGUAGE, IN SECOND LANGUAGE, . . . )

FIG. 5B
1/ TEXT ID
2/ IN FIRST LANGUAGE (JAPANESE)
3/ IN SECOND LANGUAGE (ENGLISH)
4/ IN THIRD LANGUAGE (CHINESE (SIMPLIFIED))
5/ IN FOURTH LANGUAGE (KOREAN)

FIG. 6A
1/ COOKING STYLE IN SECOND LANGUAGE (ENGLISH)
2/ INGREDIENT IN SECOND LANGUAGE (ENGLISH)

FIG. 6B
1/ DETAILED EXPLANATION ID
2/ IN FIRST LANGUAGE (JAPANESE)
3/ IN SECOND LANGUAGE (ENGLISH)
4/ IN THIRD LANGUAGE (CHINESE (SIMPLIFIED))
5/ IN FOURTH LANGUAGE (KOREAN)

FIG. 7
1/ DISH ID
2/ DISH NAME
   (IN FIRST LANGUAGE, IN SECOND LANGUAGE, . . . )
3/ SERVICE RESTAURANT ID
4/ DISH INFORMATION
   (CATEGORY (FIRST LANGUAGE), INGREDIENT (FIRST LANGUAGE), SEASONING (FIRST LANGUAGE), COOKING STYLE (FIRST LANGUAGE), DETAILED EXPLANATION (FIRST LANGUAGE)),
   (CATEGORY (SECOND LANGUAGE), INGREDIENT (SECOND LANGUAGE), SEASONING (SECOND LANGUAGE), COOKING STYLE (SECOND LANGUAGE), DETAILED EXPLANATION (SECOND LANGUAGE)), . . .

FIG. 8
3/ SHOP TERMINAL
31/ SHOP TERMINAL COMMUNICATION UNIT
32/ SHOP TERMINAL STORAGE UNIT
33/ SHOP TERMINAL OPERATION UNIT
34/ SHOP TERMINAL DISPLAY UNIT
35/ SHOP TERMINAL PROCESSING UNIT
351/ BROWSING EXECUTION UNIT
352/ TERMINAL TRANSMISSION UNIT

FIG. 9
1/ MENU ITEM REGISTRATION
908/ REGISTER
2/ DISH NAME (JAPANESE)
3/ DISH NAME (ENGLISH)
4/ DISH NAME (CHINESE)
5/ DISH NAME (KOREAN)
6/ DISH CATEGORY SELECT
7/ (LARGE CLASSIFICATION)
8/ (MIDDLE CLASSIFICATION)
9/ (SMALL CLASSIFICATION)
10/ DISH DETAILED EXPLANATION INPUT
904/ CHANGE
11/ (JAPANESE)
12/ INGREDIENT SELECT
905/ (INGREDIENT)
13/ SEASONING SELECT
906/ (SEASONING)
14/ COOKING STYLE SELECT
907/ (COOKING STYLE)

FIG. 10A
1/ DISH CATEGORY SELECT
2/ JAPANESE FOOD
3/ (MIDDLE CLASSIFICATION)
4/ (SMALL CLASSIFICATION)
1001/ JAPANESE FOOD
   GRILLED MEAT
   ITALIAN FOOD

FIG. 10B
1/ DISH CATEGORY SELECT
2/ JAPANESE FOOD
3/ UDON/ SOBA
4/ (SMALL CLASSIFICATION)
1004/ JAPANESE CUISINE
   KAPPO
   UDON/ SOBA

FIG. 10C
1/ DISH CATEGORY SELECT
2/ JAPANESE FOOD
3/ UDON/ SOBA
4/ SOBA
1007/ SOBA
   UDON
   SANUKI UDON

FIG. 11A
1/ DISH DETAILED EXPLANATION USER INPUT
1104/ INPUT
2/ (JAPANESE)
3/ (ENGLISH)
1102/ ADD LANGUAGE
1103/ DELETE

FIG. 11B
1/ PORK
9051/ PORK
   CHICKEN
   BEEF

FIG. 11C
1/ SALT
9061/ SALT
   SOY SAUCE
   MISO

FIG. 11D
1/ RAW
9071/ RAW
   ROAST/GRILLED/BAKED
   STEAMED

FIG. 12
4/ MOBILE TERMINAL
41/ MOBILE TERMINAL COMMUNICATION UNIT
42/ MOBILE TERMINAL STORAGE UNIT
43/ MOBILE TERMINAL OPERATION UNIT
44/ MOBILE TERMINAL DISPLAY UNIT
45/ MOBILE TERMINAL PROCESSING UNIT
451/ BROWSING EXECUTION UNIT

FIG. 14
3/ SHOP TERMINAL
2/ SERVER
S101/ REGISTRATION PAGE REQUEST
S102/ CREATE PAGE DISPLAY DATA
S103/ PAGE DISPLAY DATA
S104/ DISPLAY REGISTRATION PAGE
S105/ REGISTRATION REQUEST
S106/ MENU ITEM INFORMATION REGISTRATION PROCESS

FIG. 15
1/ MENU ITEM INFORMATION REGISTRATION PROCESS
2/ END
S201/ RECEIVE INPUT INFORMATION
S202/ CONVERSION PROCESS
S203/ STORE MENU ITEM INFORMATION IN MENU ITEM INFORMATION TABLE

FIG. 16
4/ MOBILE TERMINAL
2/ SERVER
S301/ DISPLAY REQUEST
S302/ DISPLAY PAGE CREATING PROCESS
S303/ PAGE DISPLAY DATA
S304/ DISPLAY PAGE

FIG. 17B
1/ INGREDIENT ID
2/ INGREDIENT NAME

FIG. 18B
1/ SEASONING ID
2/ SEASONING NAME

FIG. 19B
1/ COOKING STYLE ID
2/ COOKING STYLE NAME

1-18: (canceled)

19: A menu generation system that generates a menu of a restaurant in multiple languages, the menu generation system comprising:
a memory that stores a first menu item property in a first language and a plurality of first menu item properties in a second language in association with each other and that stores each of the plurality of first menu item properties in the second language and a second menu item property in association with each other; and
processing circuitry that:
receives a selected and input first menu item property from a user terminal in the first language and a selected and input second menu item property for a predetermined dish from among menu item properties stored in the memory, the first language being based on a setting of the user terminal,
extracts the first menu item property in the second language, stored in the memory in association with the received second menu item property, from among the plurality of first menu item properties in the second language, stored in the memory in association with the received first menu item property in the first language, and
transmits, to the user terminal, the extracted first menu item property in the second language for the predetermined dish.

20: The menu generation system according to claim 19, wherein
the second menu item properties have a tree structure with a plurality of levels including a primary level relating to a primary node and a lower level relating to one or more second menu item properties associated with lower levels than the primary level,
the memory stores a property value of each second menu item property that belongs to any one of the plurality of levels and a property value of a corresponding one of the first menu item properties in association with each other, and
the processing circuitry:
identifies a second menu item as the primary node,
extracts the primary node and one or more second menu item properties in the one or more lower levels, and
transmits the extracted primary node and the one or more second menu item properties to the user terminal.

21: The menu generation system according to claim 20, wherein
the first menu item properties have a tree structure with a plurality of levels, and
the second menu item properties have a tree structure with a plurality of levels.

22: The menu generation system according to claim 19, wherein the user terminal transmits language specification information for specifying a language in which text information is shown in the user terminal as the second language.

23: The menu generation system according to claim 22, wherein the language in which the text information is shown in the user terminal is determined based on a location of the user terminal at a particular point in time.

24: The menu generation system according to claim 19, wherein the memory stores each of the plurality of first menu item properties in the first language and a second menu item property in association with each other.

25: The menu generation system according to claim 19, wherein
the first menu item property is a cooking style, and
the second menu item property is an ingredient.

26: The menu generation system according to claim 19, wherein
the first menu item property is an ingredient, and
the second menu item property is a cooking style.

27: A menu generation method that is executed by a computer, the computer including a memory, the computer including processing circuitry being configured to generate a menu of a restaurant in one or more languages, the menu generation method comprising:
storing a first menu item property in a first language and a plurality of first menu item properties in a second language in the memory in association with each other and storing each of the plurality of first menu item properties in the second language and a second menu item property in the memory in association with each other;
receiving a selected and input first menu item property from a user terminal in the first language and a selected and input second menu item property for a predetermined dish from among menu item properties stored in the memory the first language being based on a setting of the user terminal;
extracting the first menu item property in the second language, stored in the memory in association with the received second menu item property, from among the plurality of first menu item properties in the second language, stored in the memory in association with the received first menu item property in the first language; and
transmitting, to the user terminal, the extracted first menu item property in the second language for the predetermined dish.

28: The menu generation method according to claim 27, wherein
the second menu item properties have a tree structure with a plurality of levels including a primary level relating to a primary node and a lower level relating to one or more second menu item properties associated with lower levels than the primary level, and
a property value of each second menu item property that belongs to any one of the plurality of levels and a property value of a corresponding one of the first menu item properties are stored in the memory in association with each other.

29: The menu generating method according to claim 28, further comprising:
identifying a second menu item as the primary node;
extracting the primary node and one or more second menu item properties in the one or more lower levels; and
transmitting the extracted primary node and the one or more second menu item properties to the user terminal.

30: The menu generation method according to claim 29, wherein
the first menu item properties have a tree structure with a plurality of levels, and
the second menu item properties have a tree structure with a plurality of levels.

31: The menu generation method according to claim 27, wherein the user terminal transmits language specification information for specifying a language in which text information is shown in the user terminal as the second language.

32: The menu generation method according to claim 31, wherein the language in which the text information is shown in the user terminal is determined based on a location of the user terminal at a particular point in time.

33: The menu generation method according to claim 27, wherein each of the plurality of first menu item properties in the first language and a second menu item property are stored in the memory in association with each other.

34: The menu generation method according to claim 27, wherein
the first menu item property is a cooking style, and
the second menu item property is an ingredient.

35: The menu generation method according to claim 27, wherein:
the first menu item property is an ingredient, and
the second menu item property is a cooking style.

36: A non-transitory computer-readable storage medium storing a menu generation program, the menu generation program which when executed by a computer of an information processing system causing the computer, including a memory and configured to generate a menu of a restaurant in one or more languages, to perform a menu generation method, the menu generation method comprising:
storing a first menu item property in a first language and a plurality of first menu item properties in a second language in the memory in association with each other and storing each of the plurality of first menu item properties in the second language and a second menu item property in the memory in association with each other;
receiving a selected and input first menu item property from a user terminal in the first language and a selected and input second menu item property for a predetermined dish from among menu item properties stored in the memory the first language being based on a setting of the user terminal;
extracting the first menu item property in the second language, stored in the memory in association with the received second menu item property, from among the plurality of first menu item properties in the second language, stored in the memory in association with the received first menu item property in the first language; and
transmitting, to the user terminal, the extracted first menu item property in the second language for the predetermined dish.
